(19) United States
(12) Patent Application Publication
(10) Pub. No.: US 2006/0279662 A1
(43) Pub. Date: Dec. 14, 2006

(54) Projection system and method

(75) Inventors: Yuval Kapellner, Bat Yam (IL); Golan Manor, Tel Aviv (IL); Zeev Zalevsky, Rosh HaAyin (IL); Izhar Eyal, Bat-Yam (IL); Nadav Cohen, Tel Aviv (IL); Daniel Oleiski, Herzliya (IL)

Correspondence Address: BROWDY AND NEIMARK, P.L.L.C.;624 NINTH STREET, NW, SUITE 300, WASHINGTON, DC, 20001-5303, US

(73) Assignee: Explay Ltd., Kibbutz Shfaim (IL)

(21) Appl. No.: 10/549,173

(22) PCT Filed: Mar. 16, 2004
(86) PCT No.: PCT/IL04/00249

§ 371 Date: Jun. 29, 2006

Related U.S. Application Data
(60) Provisional application No. 60/456,020, filed on Mar. 16, 2003.
(60) Provisional application No. 60/540,331, filed on Feb. 2, 2004.

(51) Int. Cl. H04N 9/31

(52) U.S. Cl. 348/744; 348/750

(57) ABSTRACT

An image projection system and method are presented to project an image on at least one of first and second projection planes. The system comprises a light source system including one or more light source assemblies operable to generate light of one or more predetermined wavelength range; a spatial light modulator (SLM) system including one or more SLM units operable to spatially modulate input light in accordance with an image to be directly projected or viewed; and two optical assemblies associated with two spatially separated light propagation channels, respectively, to direct light to, respectively, the first and second projection planes with desired image magnification. The system is configured to selectively direct the input light propagating towards the SLM system or light modulated by the SLM system to propagate along at least one of the two channels associated with the first and second projection planes, respectively.

### FIELD OF THE INVENTION

This invention relates to a projection system and method.

### BACKGROUND OF THE INVENTION

The entertainment market evolved enormously during the past several years, with the introduction of “front projection”, “rear projection” systems and near eye (direct view) systems. In a front projection system, an observer faces a front projection screen on the same side as the side on which image rays are projected, and sees the displayed picture. In a rear projection system, an observer sees a displayed picture on the side opposite to the side onto which image rays are projected. In a near eye system, the viewer views an enlarged virtual image of an SLM itself as the display (therefore called direct view)

U.S. Pat. No. 6,485,146 discloses a low-profile integrated front projection system configured to coordinate specialized projection optics and an integral screen optimized to work in conjunction with the optics to create the best viewing performance and produce the necessary keystone correction. The system has a housing assembly, a projection assembly, and an expansion assembly. The housing assembly includes a frame having a front surface that provides a front projection screen and contains other modular components. In addition, a projection assembly with a movable arm may be included, having a storage position and a projection position, and to which the front projection head may be coupled. According to one aspect, the projection assembly is modularized and has a plurality of easily replaceable component modules coupled to the housing and which operate together to project an image onto the front projection screen. According to another aspect, the integrated front projection system further has an expansion assembly coupled to the housing. The expansion assembly includes an expansion slot formed in the housing and electrically coupled to a display controller in the projection assembly and expansion modules coupled to the expansion slot. The expansion modules operate to enhance functionality of the display controller.

U.S. Pat. No. 5,285,287 discloses a projecting method and device for picture display apparatus capable of selectively operating in a front projection mode and a rear projection mode. The device comprises a projector disposed in a cabinet, a rear projection screen formed in a wall of the cabinet, and a front projection screen disposed outside the cabinet. To permit selection between the front and rear projections, the projector may be detachably mounted on the cabinet: when it is mounted the image rays are introduced into the cabinet for the rear projection, while when it is detached it can be used for the front projection. In another embodiment, a selective light guide directs the image rays either to the rear projection screen or to the front projection screen. In a further embodiment, the rear projection screen can change between transparent and translucent states. When it is transparent, the image rays are passed therethrough to the front projection screen.

WO 03/005733, assigned to the assignee of the present application, discloses an image projecting device and method. The device comprises a light source system operable to produce a light beam to impinge onto an active surface of a spatial light modulator (SLM) unit formed by an SLM pixel arrangement; and a magnification optics accommodated at the output side of the SLM unit. The light beam impinging onto the SLM pixel arrangement has a predetermined cross section corresponding to the size of said active surface. The SLM unit comprises first and second lens' arrays at opposite sides of the pixel arrangement, such that each lens in the first array and a respective opposite lens in the second array are associated with a corresponding one of the SLM pixels.

Light emitting diodes (LEDs) have been around for several years and are nowadays considered a proven technology. Due to their low output optical power, LEDs have been limited so far to simple illumination/lighting and communication applications. In the past couple of years LEDs have been able to reach several lumens, enabling the creation of small projection devices suitable for mobile, low power consumption applications. However, high optical power LEDs are not the only obstacle keeping LED based micro-projectors from being feasible. The demand for comfortable sized projection screens for mobile/portable applications requires a projection system with an output optical power of tens of lumens. A micro-projection system for mobile devices based on the currently available high power LEDs, cannot reach the required output optical power without requiring high power consumption, thus making them not yet suitable for such applications.

Current projector architectures require a commercially available component, spatial light modulator (SLM), of any kind (transmissive, reflective, etc.). The transmissive type SLM contains two sets of polarizers, which significantly attenuate the optical power. The reflective type SLM, such as LCOS modulator type, contains one polarizer but yet significantly reduces the optical output, since the light passes through the same polarizer twice. In both modulators, the first polarizer introduces a significant attenuation of the optical light (approximately 50%), due to the fact that light generated by LEDs contains random polarization. Using a polarized LED will generate a light with a specific output polarization (not a random polarization) allowing to preserve most of those 50% of light, reducing the loss of light on the first polarizer and possibly eliminating the need for the first polarizer altogether. The feasibility of such polarized LEDs has been demonstrated recently (for example: Integrated ZnO-based Spin-polarized LED, Rutgers University).

A projection system can also be realized using polarized laser sources. Polarized laser sources are as efficient as polarized LEDs from aspects of optical efficiency improvements. However, laser sources introduce new factors such as eye safety issues, speckle phenomenon handling and higher cost of system.

### SUMMARY OF THE INVENTION

There is a need in the art for a projection system, in particular miniature projection system, capable of dual projection of the same data along two spatially separated channels towards two different projection planes. These projecting channels may be front and rear projection channels, two front projection channels, two rear projection channels, or rear/front projection together with direct view near-eye channel.

The present invention provides a novel dual mode projection system and method, combining rear projection (or near eye/direct view capability) and front projection techniques in an efficient manner. The system is characterized by low power consumption and improved optical efficiency, due to the possibility of dividing the optical power between the two projection channels, e.g., when one projection channel is not used, all the optical power can be diverted to the other projection channel and vice versa. Using the present invention in a portable video camera, for example, will result in that front projection replaces a big LCD screen used for comfortable viewing of images being recorded, and rear projection is used as a viewfinder of the camera. Furthermore, the technique of the present invention provides for using larger screens in devices with viewfinder capabilities (much larger than the devices themselves), which will enable sharing the viewed information among multiple viewers. Preferably, the front and rear projection channels are implemented as a single optical path, considering the optical path associated with a Spatial Light Modulator (SLM).

Thus, according to one broad aspect of the present invention, there is provided a projection system configured to operate with at least one of first and second projection modes, the system comprising:
(i) a light source system including one or more light source assemblies, the light source assembly being operable to generate light of one or more predetermined wavelength range;
(ii) a spatial light modulator (SLM) system including one or more SLM units operable to spatially modulate input light in accordance with an image to be directly projected or viewed;
(iii) two optical assemblies associated with two spatially separated light propagation channels, respectively, to direct light to, respectively, the first and second projection planes with desired image magnification;
   the system being configured to selectively direct the input light propagating towards the SLM system or light modulated by the SLM system to propagate along at least one of the two channels associated with the first and second projection planes, respectively.

It should be understood that considering the front and/or rear projection system, what is projected is an image, an SLM being operated by data indicative of the image to be projected. In the case of near-eye/viewfinder application, one of the channels utilizes magnifying optics not to project an image but to enlarge the SLM image itself. Hence, the term “projection plane” used herein actually signifies a plane on which either an image or an image projection is displayed.

The SLM unit may be of a reflective or transmissive type.

According to one embodiment of the invention, the selective light directing is achieved by selectively affecting the polarization of light, and utilizing at least one element capable of separating between two orthogonal polarization of light (such as an optical beam splitter or magneto-optical beam splitter) to thereby define the two channels of light propagation. Such a polarization separating element will be referred to herein as “polarized beams splitter”. A controllable polarization rotator may be used upstream of the beam splitter (with respect to a direction of light propagation from the light source assembly towards the projection planes). In this case, an operational position of the polarization rotator determines the selective light propagation along one of the two channels or along both of them. The polarized beam splitter and the polarization rotator may be both accommodated upstream of the reflective-type SLM unit. A mirror assembly may be used in each of the two channels, to thereby direct a polarization light component transmitted though the polarized beam splitter onto the reflective-type SLM unit with an angle of incidence different from that of the other polarization light component reflected from the polarized beam splitter. Two polarized beam splitters may be used with a controllable polarization rotator between them. In this case the first polarized beam splitter reflects light to the reflective-type SLM, and transmits the modulated light towards the second polarized beam splitter via the polarization rotator. The polarization rotator and the polarized beam splitter may be accommodated downstream of a transmissive-type SLM and thus selectively directing the modulated light. An additional polarization rotator and a mirror may be accommodated in the optical path of the modulated light downstream of the polarized beam splitter.

According to another embodiment of the invention, the selective light directing is implemented by selectively operating a mirror in the optical path of modulated light emerging from the polarized beam splitter to thereby direct the modulated light to at least one of the channels. The mirror directs this light back to the beam splitter to be reflected by the beam splitter towards a respective one of the first and second projection planes. The polarized beam splitter may be accommodated upstream of the reflective-type SLM unit, and the mirror shiftable between its operative and operative state may be partially transparent. In this case, in the operative state of the mirror, a part of light output from the polarized beam splitter is transmitted towards one of the first and second projection planes and the other part is reflected back to the polarized beam splitter to be reflected by the beam splitter to the other projection plane. The system thus is capable of operating with both the first and second projection modes, or operating with one of these channels. Alternatively such a semi-transparent may be stationary mounted at the output of the polarized beam splitter. The system thus operates with both the first and second projection modes.

According to yet another embodiment, the selective light directing is implemented by selectively reorienting an SLM unit so as to be in either one of the two channels, which in this case are defined by two light sources or by two different positions, respectively, of the single light source.

According to yet another embodiment, the selective light directing is implemented by selectively reorienting a polarized beam splitter to be in either one of the two channels, which are defined by two light sources or by two different positions, respectively, of the single light source.

According to yet another embodiment, the selective light directing is implemented by splitting light by an array of alternating lenses and prisms into two light portions to propagate along the two channels, respectively.

According to another broad aspect of the present invention, there is provided a method for projecting an image onto at least one of first and second projection planes, the method comprising:
operating a single spatial light modulating (SLM) unit located in an optical path of input light coming from one or two light source assemblies to modulate the light in accordance with the image to be projected, the light source assembly being configured to generate light of one or more predetermined wavelength range; and operating the SLM unit to modulate input light in accordance with the image to be projected; and
selectively directing the input light propagating towards the SLM unit or light modulated by the SLM unit to propagate along at least one of first and second light propagation channels associated with said first and second projection planes, respectively.

Preferably, the light source assembly is configured to generate light of Red, Green and Blue wavelength ranges. Preferably, the light source assembly is configured to provide substantially uniform intensity distribution within a cross-section of the generated light. This is implemented by using a diffractive element.

The present invention also provides a solution for a problem associated with the following: It is often the case that to be displayed is alphanumeric and graphical information generated in mobile, battery operated devices. Such display has to create a reasonably large and clear image and consume a reasonably low amount of electric power. The present invention solves this problem by providing a micro-projector that uses low power light sources and special optics to project an image on a surface. The present invention utilizes polarized LEDs that have the potential of being even more compact/optimal/low cost than laser based projection systems.

Thus, according to yet another aspect of the present invention, there is provided a projection system for projecting a color image, the system comprising:
a light source system including at least two light source assemblies generating at least two light beams, respectively of different wavelength ranges;
a wavelength combining arrangement accommodated either in optical paths of said at least two generated light beams while propagating towards a single spatial light modulator (SLM) unit, or in optical paths of at least two modulated light beams resulting from passage of said at least two generated light beams through at least two spatial light modulator (SLM) units, respectively, the light combining arrangement thereby producing a combined multi-wavelength output light beam;
an optical arrangement accommodated in an optical path of the combined output light beam to direct it to a projection plane with a desired image magnification.

The present invention, according to its yet another aspect, provides a miniature projection system comprising: a light source system including at least two light source assemblies generating at least two light beams, respectively, of different wavelength ranges; a planar optical element operable as a waveguide for light incident thereon with an angle corresponding to a total internal reflection condition to thereby maintain substantially all the energy of the incident light within the waveguide; a first light director assembly accommodated in optical paths of the at least two generated light beams to direct them onto said planar optical element with said predetermined angle of incidence; the planar optical element carrying on its surfaces a phase modulation arrangement including at least two phase modulation element in optical paths of said at least two light beams, respectively, propagating along the waveguide, and a spectral phase adjusting element accommodated in an optical path of the phase modulated light propagating along the waveguide, the phase modulation arrangement and the spectral phase adjusting element acting together to provide beam shaping and wavelength combining to enable combining of said at least two light beams of different wavelengths into a combined light beam and direct the combined light beam towards a spatial light modulator (SLM) unit.

Preferably, the system also comprises a phase correction arrangement including at least two phase correction elements in optical paths of the at least two light beams, respectively, with the modulated phases, propagating towards the spectral phase adjusting element.

According to yet another aspect of the present invention, there is provided a method for use in combining at least two light beams of different wavelengths into a combined light beam, the method comprising passing said at least two light beams via a wavelength combining element in the form of a diffractive grating with an increased depth pattern.

The wavelength combining element is generated by a recording process using a mask positioned at a given distance from a recording surface, such that given a special transformation relating a plane of the mask and the recording surface generate a desired profile on the recording surface.

### BRIEF DESCRIPTION OF THE DRAWINGS

In order to understand the invention and to see how it may be carried out in practice, preferred embodiments will now be described, by way of non-limiting examples only, with reference to the accompanying drawings, in which:

FIG. 1 is a schematic illustration of a projection system of the present invention;

FIGS. 2A to 2D illustrate four examples, respectively; of the image projection system of the present invention, wherein FIGS. 2A and 2D show two different system configurations based on the use of a single reflective-type SLM unit; FIG. 2B shows the use of a single transmissive-type SLM unit; and FIG. 2C shows the use of two transmissive-type SLM units for two light propagation channels, respectively;

FIG. 3 illustrates an image projection system according to another example of the present invention, utilizing a selective light director assembly configured to obtain light output towards two channels in opposite directions, respectively;

FIG. 4 shows an image projection system according to yet another example of the present invention, utilizing a single SLM unit and a mirror with the reflectivity defining the light division between two channels;

FIG. 5 exemplifies yet another embodiment of the present invention, utilizing a single SLM unit and a movable mirror, the position of the mirror defining light propagation towards one of the two channels;

FIG. 6 exemplifies an image projection system of the present invention, utilizing a single SLM unit with an array of alternating micro-lenses and prisms to thereby use half of the SLM's pixels for the front projection and the other half for the rear projection, thus allowing different images to be displayed on each channel using only one SLM;

FIG. 7 shows yet another example of the invention, utilizing a single SLM unit rotatable to enable light propagation to either one of two channels;

FIGS. 8A and 8B illustrate an image projection system of the present invention, utilizing a single SLM unit and a selective light director which is rotatable to direct light to either one of two channels;

FIG. 9 illustrates a projection channel of the present invention including three light sources generating light of three different wavelength ranges, respectively, associated with a single reflective-type SLM unit;

FIG. 10 illustrates a projection channel of the present invention including three light sources associated with three reflective-types SLM units, respectively, and a color combining cube;

FIG. 11 illustrates a projection channel of the present invention including three light sources associated with a single transmissive-types SLM unit;

FIG. 12 illustrates a projection channel of the present invention including three light sources associated with three transmissive-types SLM units;

FIG. 13 illustrates a projection channel of the present invention including a white-color light source and a single transmissive-type SLM unit;

FIG. 14 illustrates a projection channel of the present invention including a white-color light source and a single reflective-type SLM unit;

FIGS. 15A and 15B schematically illustrate a projection system of the present invention configured to of a very small size;

FIGS. 16A and 16B more specifically illustrate optical elements of the present invention that can be used in the ultra-small projection system;

FIG. 17 illustrates a tophatlet element suitable to be used in the projection systems of FIGS. 15A-15B, 16A and 16B;

FIG. 18 more specifically illustrates the operational principles of a wavelength combining element used in the projection systems of FIGS. 15A-15B, 16A and 16B; and

FIG. 19 demonstrates how the present invention is used for correcting eye deformations (in viewers with eyeglasses) within a projection system.

### DETAILED DESCRIPTION OF THE INVENTION

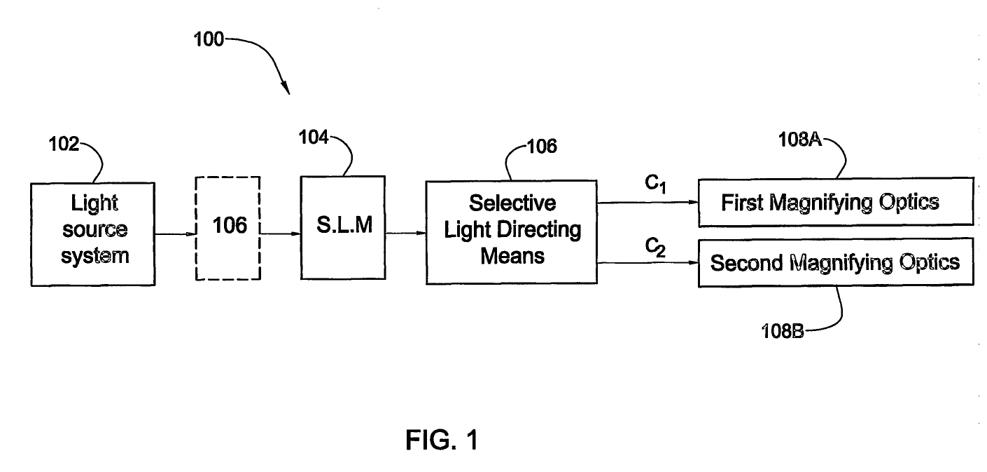

Referring to FIG. 1, there is schematically illustrated a projection system 100 of the present invention. The system 100 includes a light source system 102; a spatial light modulator (SLM) system 104; a means for selective light directing 106; and first and second magnifying optics 108A and 108B associated with, respectively, first and second projection channels.

The light source system 102 includes one or more light source assemblies, each with one or more light emitting elements. Preferably, an RGB-source assembly is used. It should be noted, that the light source system preferably includes an optical arrangement operable to provide substantially uniform intensity distribution within the cross-section of the emitted light beam. This optical arrangement includes a diffractive element, commonly referred to as “top-hat”. The light source assembly is preferably of a kind producing a highly polarized light beam.

The SLM system 104 may be configured to operate in light transmitting or light reflecting mode. Preferably, the system of the present invention utilizes a single SLM unit, but may utilize two SLM units, each for respective one of the two projection channels. The construction of the SLM unit is known in the art and therefore need not be specifically described, except to note that it comprises a two-dimensional array of active cells (e.g., liquid crystal cells) each serving as a pixel of the image and being separately operated by a modulation driver to be ON or OFF and to perform the polarization rotation of light impinging thereon, thereby enabling to provide a corresponding gray level of the pixel. Some of the cells are controlled to let the light pass therethrough without a change in polarization, while others are controlled to rotate the polarization of light by certain angles, according to the input signal from the driver.

It should be noted that other SLM technologies, that do not employ polarization (e.g. micro-mirrors), can also be used in the present invention. Preferably, the SLM unit includes lenslet arrays upstream and downstream of the SLM pixel matrix in order to improve the fill factor of the SLM. This concept is described in the above-indicated WO 03/005733, assigned to the assignee of the present application.

The means for selective light directing is designed to direct light to propagate towards either one of two projection channels or both of them. It should be noted that the means for selective light directing may and may not be constituted by any physical element. For example (as will be described further below) such means may be implemented by displacing the SLM unit between its different operational positions. The physical elements of the light director 106 may be accommodated upstream or downstream of the SLM and may include parts located upstream and parts located downstream of the SLM.

It should also be noted that the first and second projection channels may be front and rear projection channels, two front projection channels, two rear projection channels or rear/front projection together with direct view near-eye channel. In the examples described below, these channels (namely their magnifying optics) are illustrated as designed for, respectively, front and rear projection modes, but the present invention is not limited to these examples.

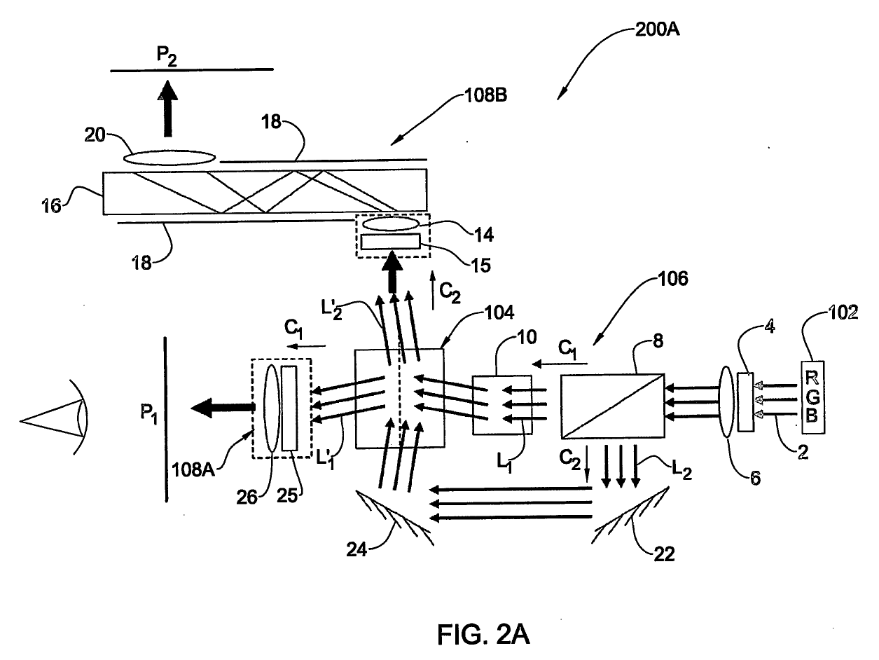

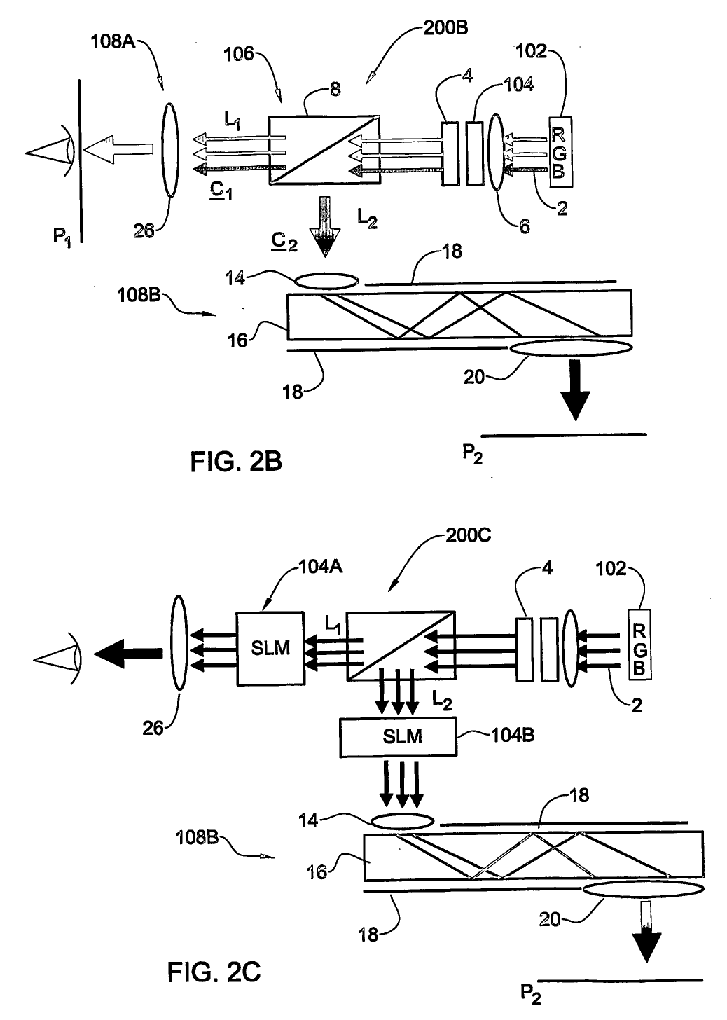

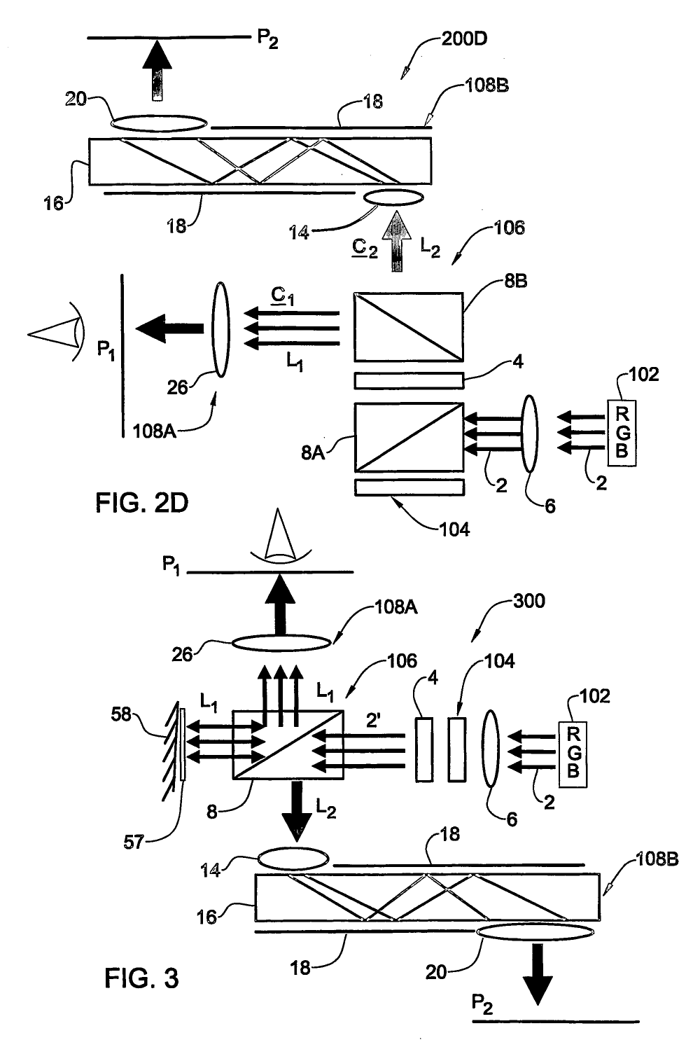

Reference is made to FIGS. 2A-2D exemplifying different configurations of the projection system of the present invention. To facilitate understanding, the same reference numbers are used to identify common components in all the examples of the invention. In these examples, a light source assembly is of the kind producing polarized light. It should be understood that this could be achieved either by using polarized light emitting element(s), or by using a polarizer at the output of light emitting element(s). A light source of any type can be used laser, light emitting diode, etc.

In the example of FIG. 2A, a projection system 200A configured to operate with at least one of front or rear projection modes. The system 200A includes a light source system formed by a single light source assembly 102 producing a light beam 2; a selective light director means 106 configured for selectively directing light to propagate through either one of light channels C₁ and C₂ or both of them towards front and rear projection planes P₁ and P₂; a single reflective-type SLM unit 104 (such as AMLCD, LCOS or micro-mirror type); and magnifying optics 108A and 108B associated with channels C₁ and C₂, respectively. Also preferably provided in the system 200A is a lens arrangement 6 configured to appropriately expand/collimate the light beam 2.

The light director assembly 106 includes a polarization rotator 4 (half-wavelength plate, e.g., single pixel liquid crystal cell), a polarized beam splitter 8, and mirrors 10, 22 and 24. The polarization rotator 4 along with the polarized beam splitter 8 determine the amount of light directed towards the front projection channel C₁ and the amount of light directed to the rear projection channel C₂, defined by the rotation angle of the polarization rotator in relation to the beam splitter. Mirror 10 appropriately deflects light component L₁ transmitted through the polarized beam splitter to obtain a desired angle of incidence of this light component onto the SLM unit to thereby achieve reflection of the output (modulated) light L′₁ from the SLM towards the front projection plane (an angle equal to that of the incidence angle). Mirrors 22 and 24 appropriately direct the other light component L₂ reflected by the beam splitter to provide a desired angle of incidence of this light component onto the SLM unit (a 90 degrees angle relative to the front projection path) to achieve reflection of the output (modulated) light L′₂ towards the rear projection plane. As shown in the figure, light components L₁ and L₂ enter the SLM unit 104 along axes forming a 90-degree angle between them, and thus two images can be formed in different locations.

The light beam 2 impinging onto the beam splitter (after being expanded by lens 6) has previously been either affected by the polarization rotator 4 or not, depending on the operational mode of the system. The beam splitter 8 splits the light beam according to the rotation portion of the light. For example, if the light beam 2 was 90-degree rotated by the polarization rotator 4, then s-polarized light produced by the light source 102 would turn to p-polarization and vice versa. Rotation for any angle from zero to 90 degrees would result in mixed types of polarizations, and the light is then split by the beam splitter 8 into two linearly polarized light components propagating through channels C₁ and C₂, respectively.

The optical assembly 108A, accommodated in the optical path of light component L′₁, includes a polarizer 25 and an imaging lens 26, and projects this light component onto the projection plane P₁. The optical assembly 108B includes a magnifying lens 14 (with a polarizer 15 upstream thereof); and an optical element 16 made of a transparent material such as glass, organic material, air, etc., and formed with two mirrors 18 arranged in a spaced-apart parallel relationship at opposite sides of the element 16, which thus serves as a light propagation path. Light L′₂ passes polarizer 15 and lens 14, and is magnified and aligned with the propagation path 16 where light L′₂ bounces between mirrors 18 thus passing larger distance causing this light beam to exit the propagation path through a lens 20 in the desired magnified size and be projected onto the rear projection plane P₂.

It should be noted that additional polarizers can be added in the optical path to adjust the light polarization as needed. The provision of optical element 16 is optional, and can be replaced by a simple magnifying lens if it is to be used as a viewfinder or an imaging lens for front/rear projection. In order to implement a rear projection module within handheld devices or other devices which require to stay thin in their physical shape, it is required to minimize a distance between the imaging lens of this module and the SLM unit and yet to maintain the desired magnification, the optical element 16 describes a way of doing so by bouncing the light within the element to pass a larger distance through the element before it is directed to the imaging lens and from there to the rear projection plane. Planar optics may be utilized to achieve this as well.

A projection system 200B of FIG. 2B is also configured for operating either one of front or rear projection modes, or both of them. Here, the single transmissive-type SLM unit 104 is used. The light source system includes a single light source assembly 102, which, similar to that of FIG. 2A is configured for generating a light beam 2 of RGB wavelength ranges. This light beam 2 is directed, via a collimating/expanding lens 6, towards the SLM unit 104. Output modulated light is directed onto a polarization rotator 4 (half-wavelength plate, e.g., a single pixel LC cell). The polarization rotator 4 along with a polarized beam splitter 8 determine the amount of light directed towards a front projection channel C₁ and the amount of light directed to the rear projection channel C₂, as described above with reference to FIG. 2A. The light propagation scheme is shown in the figure in a self-explanatory manner.

It should be noted that instead of operating with the single SLM unit, two such SLM units can be used. This is illustrated in FIG. 2C. As shown, a system 200C is generally similar to system 200B, but distinguishes therefrom in that it includes two transmissive-type SLM units 104A and 104B, one in the optical path (channel C₁) of light component L₁ transmitted through the polarized beam splitter 8 and the other in the optical path (channel C₂) of light component L₂ reflected by the beam splitter 8.

In the example of FIG. 2D, a projection system 200D utilizes a single reflective-type SLM unit 104 (such as AMLCD or LCOS) and a single light source assembly 102 (RGB-light source). The selective light director assembly 106 includes two beam splitters 8A and 8B and a polarization rotator 4 between them. Similarly to the previously described examples, the system 200D preferably includes a collimating/expanding lens arrangement 6.

The system 200D operates in the following manner: light beam 2 coming from the light source assembly 102 passes through the lens 6 which directs the beam in a parallel manner towards the polarized beam splitter 8A. The latter is appropriately designed in accordance with the polarization of the light source, to reflect the light beam 2 towards the SLM unit 104 to be spatially modulated in accordance with an image to be viewed (projected). The modulated light is directed back to the polarized beam splitter 8A and continues to the polarization rotator 4, where the light can be shifted in polarization type, and output towards the second polarized beam splitter 8B. The latter reflects and transmits modulated components L₁ and L₂, respectively, according to the polarization types of the modulated light coming from the polarization rotator 4 (i.e., according to whether the polarization rotator is in its inoperative or operative position). Light component L₁ propagates towards an optical system 108A to form an image on the front projection plane P₁, and light component L₂ propagates to an optical system 108B to form an image on a rear projection plane P₂.

Reference is made to FIG. 3 illustrating a projection system 300 according to another example of the present invention. As indicated above, the same reference numbers identify components that are common for all the examples of the invention. The system 300 includes a single light source assembly 102; a single transmissive-type SLM unit 104; a selective light director assembly 106 formed by a polarized beam splitter 8, a polarization rotator 4 between the beam splitter 8 and the SLM unit 104, a λ/4/polarization rotator plate 57, and a mirror 58 accommodated in the optical path of light component L₁ transmitted through the polarized beam splitter 8; and optics 108A and 108B. A light beam 2 from the light source 102 passes through a lens arrangement 6, is modulated by the SLM unit 104, and is then directed towards the polarization rotator 4. The polarization rotator 4 along with polarized beam splitter 8 determine the amount of light directed towards the front projection channel C₁ and the amount of light directed to the rear projection channel C₂ (directing the amount of light flow is determined by the rotation angle of the polarization rotator in relation to the beam splitter). The light component L₁ passes through the λ/4/polarization rotator plate 57 and is then reflected by mirror 58 back causing its polarization to be rotated 90° and then to the beam splitter 8 which reflects this light component L₁ towards the optics 108A. This configuration results in that light components L₁ and L₂ propagate towards respective projection planes along parallel axes. It should be noted, although not specifically shown, that the single SLM unit may be replaced by two SLM units, one placed between the beam splitter 8 and the optical system 108A and the other between the beam splitter and optical system 108B.

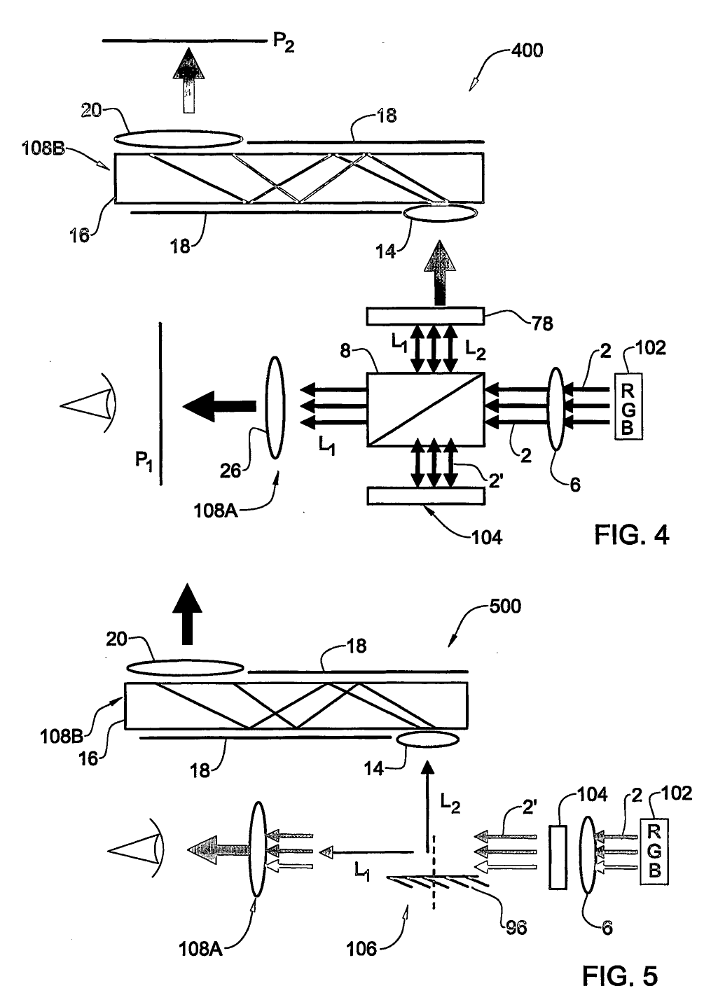

FIG. 4 exemplifies yet another projection system 400 according to the invention. The system 400 is generally similar to the above-described examples, namely includes a light source assembly 102, a single reflective-type SLM unit 104, a selective light director means 106, and optical systems 108A and 108B; and distinguishes from the previously described examples in that the selective light director 106 has no polarization rotator, but is formed only by a polarized beam splitter 8 and a mirror 78. A polarized light beam 2 produced by the light source 102 passes a lens 6, and is directed as a parallel beam onto the polarized beam splitter 8, which is appropriately designed to reflect the polarized light beam towards the SLM unit 104. A modulated light 2′ is reflected by the SLM unit 104 back into the polarized beam splitter 8, which transmits this light 2′ towards the optical system 108B.

The mirror 78 may be stationary mounted in the optical path of light 2′ and be designed as semi-transparent. In this case, the system 400 will concurrently operate in both front and rear projection modes: A part L₁ of light 2′ will be reflected by the mirror 78 back into the beam splitter, which will reflect this light L₁ to the optics 108A to be directed to a front projection plane P₁, while the remaining part L₂ of light 2′ will be transmitted by mirror 78 to the optics 108B to be directed to a rear projection plane P₂.

Alternatively or additionally, the mirror 78 may be shiftable between its operative position being in the optical path of light 2′ output from the beam splitter 8, and its inoperative position being outside this optical path. In this case, if the mirror is semi-transparent, the system will selectively operate in both front and rear projection modes (when in the operative position of the mirror 78) or only rear projection mode (when in the inoperative position of the mirror). If the mirror is highly reflective, the system will selectively operate in rear projection mode when in the inoperative position of the mirror, or front projection mode when in the operative position of the mirror.

FIG. 5 illustrates yet another example of the invention. Here, a projection system 500 utilizes a single polarized light source assembly 102, a single transmissive-type SLM unit 104, a selective light director assembly 106 formed by a mirror 96 shiftable between its operative and inoperative states, and optics 108A and 108B. A polarized light beam 2 produced by the light source 102 passes a lens 6 and enters the SLM unit 104. A modulated light 2′ transmitted through the SLM unit 104 propagates towards the front projection optics 108A. When mirror 96 is in its inoperative position, i.e., outside the optical path of light 2′, the system operates in the front projection mode only. When the mirror 96 is in its operative state (e.g., rotated) such that its reflective surface faces the output of SLM unit 104, output light 2′ is reflected by the mirror 96 towards the rear projection optics 108B, and the system thus operates in rear projection mode only.

Mirror 96 can be of an electrically powered rotating type and can be controlled according to duty cycle operation on what would be the portion of the light to each channel. It should be noted, although not specifically shown that the transmissive-type SLM unit can be replaced by a reflective-type SLM unit.

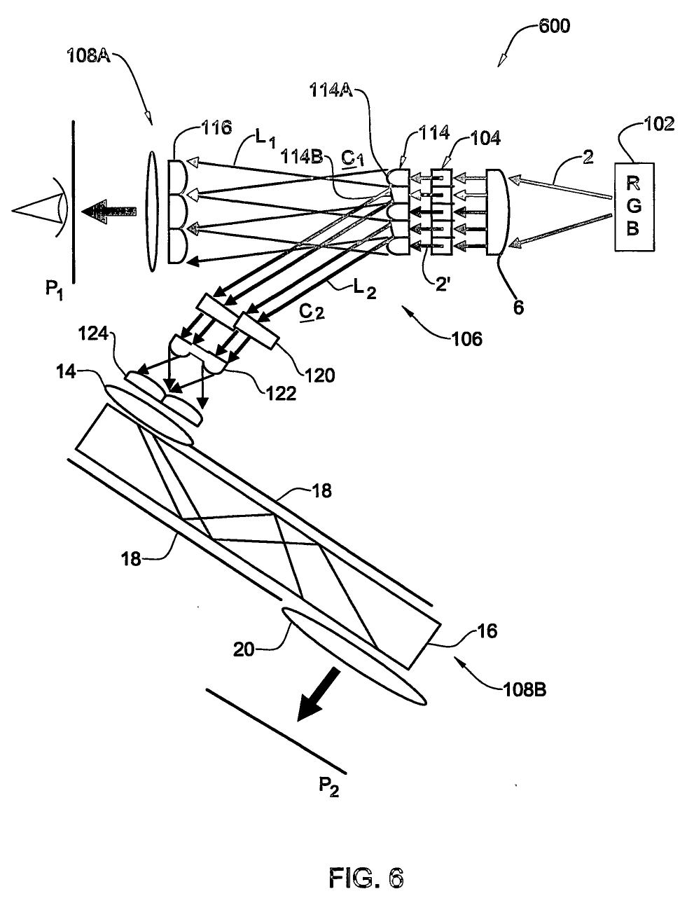

FIG. 6 illustrates an image projection system 600 according to yet another embodiment of the invention. The system 600 includes such main constructional parts as a light source system formed by a single light source assembly 102; an SLM arrangement formed by a single transmissive-type SLM unit 104 (which may be replaced by a reflective-type SLM); a selective light director assembly 106; and image magnifying optical systems 108A and 108B. The light director assembly 106 is accommodated downstream of the SLM unit 104, and includes a lenslet array 114 formed by micro-lenses 114A alternated with micro-prisms 114B. Preferably, the light director assembly 106 also includes a second array 120 of prisms for correcting for dispersion introduced by the prisms 114B of the first array 114, and micro-lens arrays 116, 122 and 124. the system 600 operates as follows:

A polarized light beam 2 produced by the light source 102 passes through a collimating/expanding lens arrangement 6, and is directed to the SLM unit 104. Modulated light 2′ output from the SLM unit (transmitted through the SLM in the present example) impinges onto the lenslet array 114. The latter splits the light 2′ into two light portions—light portion L₁ formed by light components impinging onto the micro-lenses 114A and propagating therethrough along a first channel C₁ towards the front projection optics 108A, and light portion L₂ formed by light components impinging onto the micro-prisms 114B and being deflected thereby to propagate along a channel C₂ towards the rear projection optics 108B.

Hence, in this architecture, half of the image pixels are used for the front projection image and the other half for the rear projection image, thus in each image a gap of one pixel is being formed between every two pixels. In order to close this formed gap and create an image with pixels consecutive to each other, secondary lenslet arrays are required both in the rear projection and front projection channels to make the necessary corrections.

In the front projection channel, light portion L₁ passes through the lenslet array 114, is directed to the lens array 116 (containing consecutive lenses), and is transferred to a parallel form and projected through optics 108A onto the front projection plane P₁.

In the rear projection channel, the light portion L₂ needs two optical transformations in order to be corrected. Since the modulated light 2′ which entered the lenslet array 114 contained several wavelengths (RGB wavelengths), each wavelength is deflected by the prisms 114B with a different angle, thus the second micro-prism array 120 is needed in order to regroup the wavelengths back to their original form. An image which has been corrected by micro-prism array 120 still has a gap of one pixel between each two pixels, which effect is corrected by further passing this light through the lenslet array 122 and lenslet array 124 which together transform the image into an image with pixels consecutive to each other (eliminating the gaps).

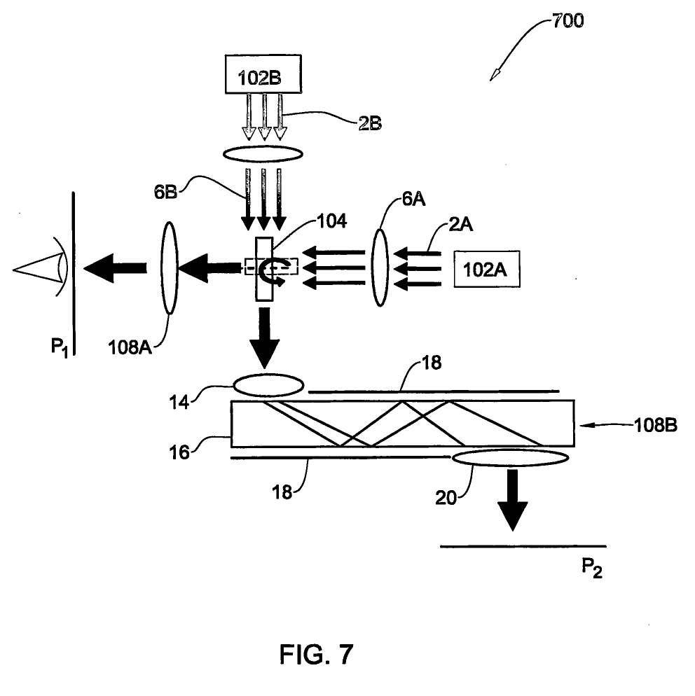

Referring to FIG. 7, there is illustrated a projection system 700 according to yet another example of the invention. The system 700 includes a light source system formed by two light source assemblies 102A and 102B; a single transmissive-type SLM unit 104 (which may be replaced by a reflective-type SLM); a means 106 for selective light directing; and image magnifying optical systems 108A and 108B. Here, the selective light directing means 106 is constituted by a drive mechanism (not shown) associated with the SLM unit so as to shift (rotate) the SLM unit between its two different operational positions: In the first operational position the input facet of the SLM unit faces the light propagation channel C₁ defined by the light source 102A. In the second operational position of the SLM (shown in the figure in dashed lines), its input facet faces the light propagation channel C₂ defined by the light source 102B.

It should be noted that the light sources 102A and 102B can be of substantially different power outputs to fit projection and near eye direct viewing respectively. It should be understood that the SLM unit can be electrically rotated or manually rotated, the term “drive mechanism” thereby signifying automatic or manual mechanism. The SLM unit may be oriented to be rotated on a different axis depending on the device's physical properties.

Thus, in the front projection mode of the system, the light source 102A is operated and light source 102B is inoperative. A light beam 2A generated by the light source 102A passes a collimator/expander 6A and enters the SLM unit 104, which in appropriately rotated to be in its first operational position. Modulated light 2A′ emerges from the SLM unit (transmitted therethrough in the present example) and propagates to the front projection optics 108A. In the rear projection mode of the system, the light source 102A is inoperative and light source 102B is operative, and the SLM unit 104 is in its second operative position. A light beam 2B generated by the light source 102B passes a collimator/expander 6B and enters the SLM unit 104. Modulated light 2B′ emerges from the SLM unit and propagates to the rear projection optics 108B.

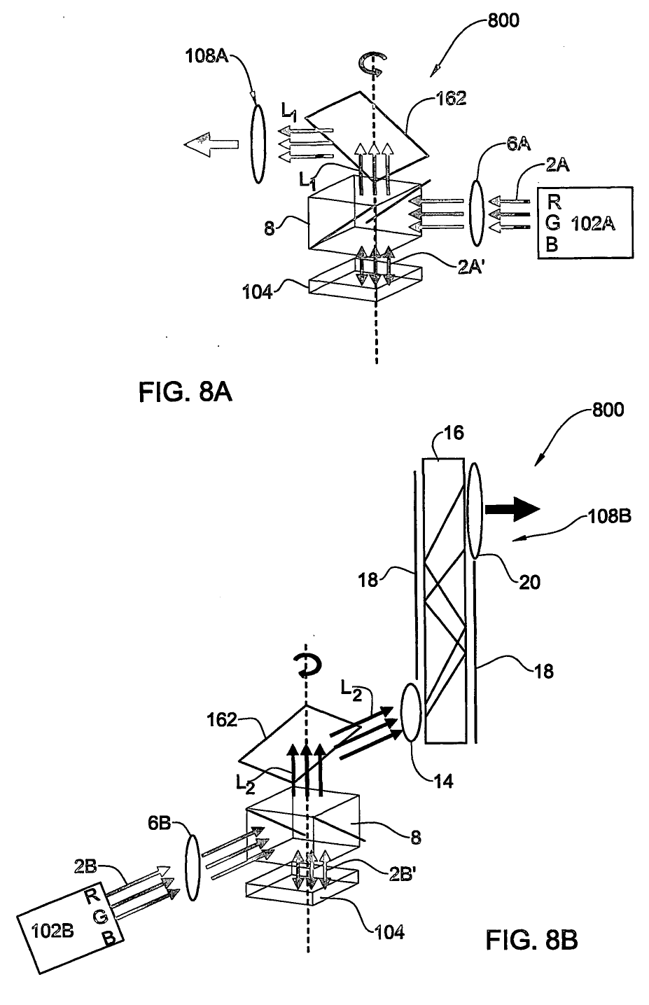

Reference is now made to FIGS. 8A and 8B illustrating an image projection system 800 according to yet another example of the invention. The system 800 includes a light source system formed by two light source assemblies 102A and 102B (each generating a polarized RGB-light beam); a single reflective-type SLM unit 104; a selective light director 106; and magnifying optics 108A and 108B. The selective light director 106 includes a polarized beam splitter 8 and a mirror 162, and is rotatable about an axis parallel to that of propagation of light reflected by the SLM unit so as to be shifted between its first and second operational positions. FIG. 8A shows the system in the first operational position of the selective light director 106, in which the system operates in the front projection or viewfinder mode. In this case, light source 102A is operative and light source 102B is not. FIG. 8B shows the system in the second operational position of the selective light director 106, in which the system operates in the rear projection mode. In this case, light source 102B is operative and light source 102A is not.

Thus, as shown in FIG. 8A, a light beam 2A generated by the light source 102A is collimated/expanded by a lens 6A and directed onto the polarized beam splitter 8, which reflects the light beam 2A to the SLM unit 104. Modulated light 2A′ reflected from the SLM unit back to the beam splitter 8, is transmitted through the beam splitter to the mirror 162, which reflects this light 2A′ to the front projection optics 108A.

As shown in FIG. 8B, the selective light director (beam splitter 8 and mirror 162) is 90-degree rotated about an axis parallel to the light propagation axis from the SLM unit. A light beam 2B generated by the light source 102B is collimated/expanded by a lens 6B and directed onto the polarized beam splitter 8, which reflects the light beam 2B to the SLM unit 104. Modulated light 2B′ reflected from the SLM unit back to the beam splitter 8, is transmitted through the beam splitter to the mirror 162, which reflects this light 2B′ to the rear projection optics 108B.

It should be noted that for all of the above mentioned drawings one of the projection channels could be replaced by magnifying optics to be used as a direct view viewfinder. In this case substantially different power output may be used for the two channels.

It should be noted that in all the above examples, the SLM unit may include lenslet arrays upstream and downstream of the SLM pixel arrangement in order to improve the fill factor of the SLM. This concept is described in the above-indicated WO 03/005733, assigned to the assignee of the present application.

It should also be noted that, although in all the above examples the systems are designed to combine rear projection with front projection, the same principles could be used for dual front projection (both channels are front projection) or dual rear projection (both channels are rear projection).

It should also be noted that in all the examples of the present invention instead of linearly polarized light beams of orthogonal polarization, also circularly polarized light beams of orthogonal polarization could be used. These circular polarizations could be generated by the light source itself (e.g., polarized LEDs) or by passing linearly polarized light generated by the light source through a quarter wave plate (λ\4) and then splitting the light by a magneto-optical beam splitter.

The present invention also solves a problem associated with the following. It is often the case that hat is to be displayed is alphanumeric and graphical information generated in mobile, battery operated devices. Such display has to create a reasonably large and clear image and consume a reasonably low amount of electric power.

The present invention solves this problem by providing a micro-projector that uses low power light sources and special optics to project an image on a surface. The present invention utilizes polarized LEDs that have the potential of being even more compact/optimal/low cost than laser based projection systems. Due to the nature of color perception by the human eye, the combination of red, green and blue light sources are sufficient to generate all perceived colors. To generate white light, the required optical power is substantially different for each color requiring about 70% in green 23% in red and 7% in blue (this may vary depending on the white color temperature required). The power conversion efficiencies (i.e. electrical power input to optical power output) and cost may also differ substantially for the different colors. It should be noted that in some cases it would be optimal for the system to contain a mixture of light sources, for example: polarized LEDs, polarized/non-polarized laser light sources and non-polarized LEDs mixed together and serve as the system's optical sources. The present invention provides for a combination of polarized LEDs together with the right optical architecture to achieve all the requirements of today's mobile and computing devices including comfortable sized images in reasonable room light conditions, low power consumption and high resolution/high quality projected images.

Following are some examples of the present invention for forming a projected color image, which can be used in the above described projection systems.

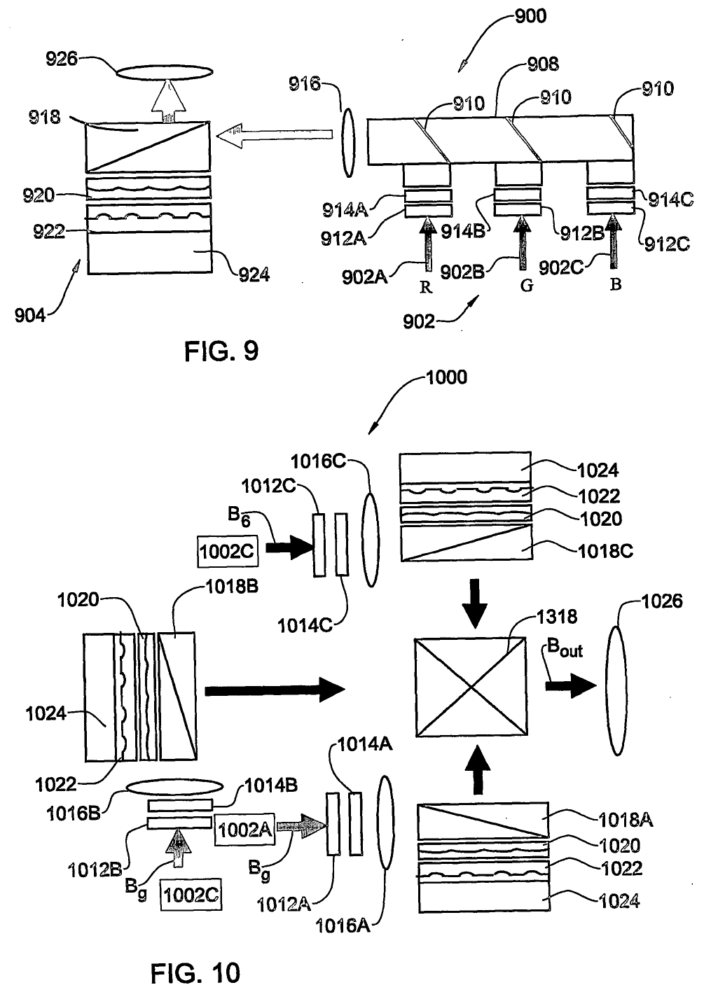

FIG. 9 illustrates a projection system 900 utilizing a polarized light source system 902; a reflective-type SLM system 904 (AMLCD or LCOS type); a periscope arrangement 908; a focusing lens arrangement 916; a polarization beam splitter 918. The SLM system 904 latter includes an SLM pixel arrangement (the LC pixel assembly) 924 and two lenslet arrays in front of the pixel arrangement. Preferably, the pixel arrangement and the lenslet arrays are integrated in a common SLM unit, as described in the above-indicated WO 03/005733, assigned to the assignee of the present application.

The light source system 902 includes Red-, Green-, and Blue-color light sources (light emitting diodes) 902A, 902B and 902C, respectively, which produce polarized or partially polarized light. Light beams generated by these light sources are preferably directed through polarizing modification elements, designated respectively, 912A, 912B and 912C, such as for example a quarter wave plates, the provision of which is optional and is aimed at modifying polarization qualities, for example converting circular polarization to linear polarization. These light beams then preferably pass through diffractive components (top-hat) 914A-914C, the provision of which is also optional and is aimed at converting the Gaussian form of light to a square even light with uniform intensity. It should be noted that, generally, instead of using a diffractive component for each light source, only one diffractive component may be used, being accommodated between the periscope 908 and the focusing lens 916. Similarly, instead of using three polarization modification elements, one per light source, a single polarization modification element may be used between the periscope and the focusing lens.

The periscope 908 contains thin film mirrors 910 to thereby allow transparency for given wavelengths and reflect the other wavelengths, thus allowing pointing all three light sources to the same output coordinates. Light output from the periscope passes through the focusing lens 916 that focuses this light onto a polarization beam splitter 918 in a manner to cover the entire entrance area of the beam splitter. A particular polarization component of the input light is reflected by the beam splitter towards the first lens array 920, and is then focused and condensed by the second lens array 922 (to be condensed to a pixel size), and transmitted in a parallel form towards the LC pixel assembly 924. The light thus passes through every active pixel relatively, and then, being modulated and reflected back from a back mirror coating (not shown), returns to the beam splitter 918.

The R, G, B combination needed to form a colorful image can be generated either by color frame sequential manner in the same pixels (i.e., each color is sequentially modulated by the SLM frame after frame) or refracted by lenslet arrays to form all the required colors in separate pixels, in order to create a color image. As the returned light is polarized opposite to the input light, the returned light passes through the polarizing surface of the beam splitter 918 and is then magnified and projected forward by an imaging lens 926.

It should be noted that the system 900 can contain a mixture of light sources, for example: polarized LEDs, polarized/non-polarized laser light sources and non-polarized LEDs mixed together and serve as the system's optical sources. It should also be noted that although the use of lens arrays is preferred (increasing optical efficiency), it is not mandatory and the modulator and system can be used without any lens arrays. It should also be noted that although the use of polarization modification components is in some cases preferred, for example for converting circular polarization to linear polarization, it is not mandatory and the modulator and system can be used without any such components or that such components may be an integral part of the light source. Additionally, it should be noted that although the use of diffractive components is preferred (improves uniformity of light), it is not mandatory and the modulator and system can be used without any diffractive components. The light sources may include internal optical components known in the art, such as: collimating lens.

Turning back for example to FIG. 2A, it should be understood that light source assembly 102 may be constituted by the assembly of FIG. 9 formed by light sources 902A-902C and periscope 908 (and preferably also elements 912A-912C and 914A-914C).

FIG. 10 exemplifies a projection system 1000 using a light source system including polarized/partially polarized LEDs 1002A, 1002B and 1002C; and a reflective-type SLM system including three SLM units 1004A, 1004B and 1004C. Polarized red-, green- and blue-color light beams Bᵣ, B_{g} and B_{b}, after being modulated by the SLM units 1004A, 1004B and 1004C, respectively, propagate towards a color combining cube 44, which delivers light to an imaging lens 1026. Preferably, each of these beam propagate towards its respective SLM unit via a polarizing modification element (1012A for beam Bᵣ, etc.) and a diffractive component (1014A for beam Bᵣ, etc.). Each of the beams then continues towards a focusing lens (1016A for beam Bᵣ, etc.) that focuses the beam onto a respective polarization beam splitter (1018A beam Bᵣ, etc.). The latter reflects the particular polarization component of the beam towards the respective SLM unit (1004A beam Bᵣ, etc.), where the beam passes through a first lens array 1020, is focused and condensed by a second lens array 1022 (to condense the beam to a pixel size), is transmitted in a parallel form towards an LC pixel assembly 1024, and is modulated and reflected back from a back mirror coating (not shown) towards the respective beam splitter. The latter transmits the returned light of the opposite polarization (as compared to that of the input light) towards the color combining cube 44 combines all three color modulated images and transmits output light beam Bₒᵤₜ indicative of a combined colored image towards an imaging lens 1026 to be thereby appropriately magnify and project the image onto a screen.

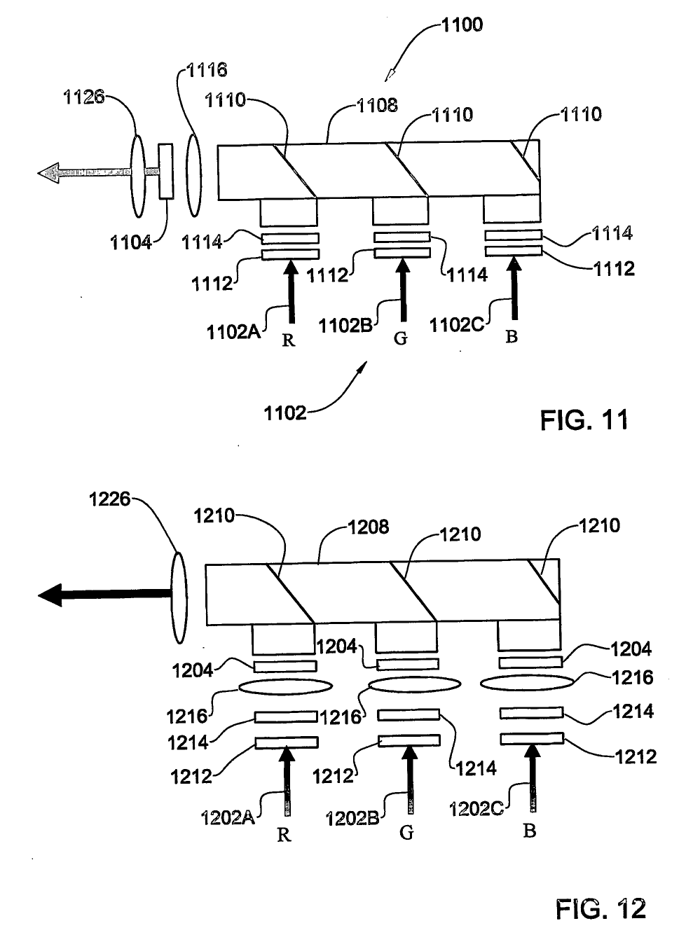

FIG. 11 exemplifies a projection system 1100 using a polarized light source system 1102 including Red-, Green- and Blue-color light sources 1102A, 1102B and 1102C; a transmissive-type SLM unit 1104; a periscope arrangement 1108; a focusing lens arrangement 1116; and imaging optics 1126. Similarly to the previously described example, the light sources are polarized or partially polarized. Light beams generated by the light sources, while propagating towards the periscope 1108, preferably pass through modification elements 1112 and diffractive components 1114. The periscope 1108 contains thin film mirrors 1110 to thereby allow transparency for given wavelengths and reflect the other wavelengths, thus allowing pointing all three light sources to the same output coordinates. The so-processed light then passes through the focusing lens 1116 that focuses the light beam in a desired size towards the SLM 1104 (preferably containing lens arrays on both sides of the LC matrix to improve optical efficiency) in a manner to cover the entire entrance area of the SLM. The R, G, B combination needed to form a colorful image, can be generated either by color frame sequential manner in the same pixels (i.e. each color is sequentially modulated by the SLM frame after frame) or refracted by lenslet arrays to form all the required colors in separate pixels, in order to create a color image. The modulated beam is then magnified and projected forward by the imaging lens 1126.

FIG. 12 shows a projection system 1200 using polarized or partially polarized light sources 1202A, 1202B and 1202C generating, respectively. red-, green-, and blue-color light. These light beams, while propagating towards a periscope 1208 (including thin mirrors 1210) pass through polarizing modification elements 1212, and diffractive components 1214. The so-reshaped light beams are then focused through focusing lenses 1216 on clear apertures of SLM units 1204 (optionally containing lens array on both sides of the LC to improve optical efficiency) in a manner to cover the entire entrance area of the SLM. The periscope 1208 allow transparency for given wavelengths and reflect the other wavelengths, thus allowing pointing all three light sources to the same output coordinates. A modulated light beam is then magnified and projected forward by an imaging lens 1226.

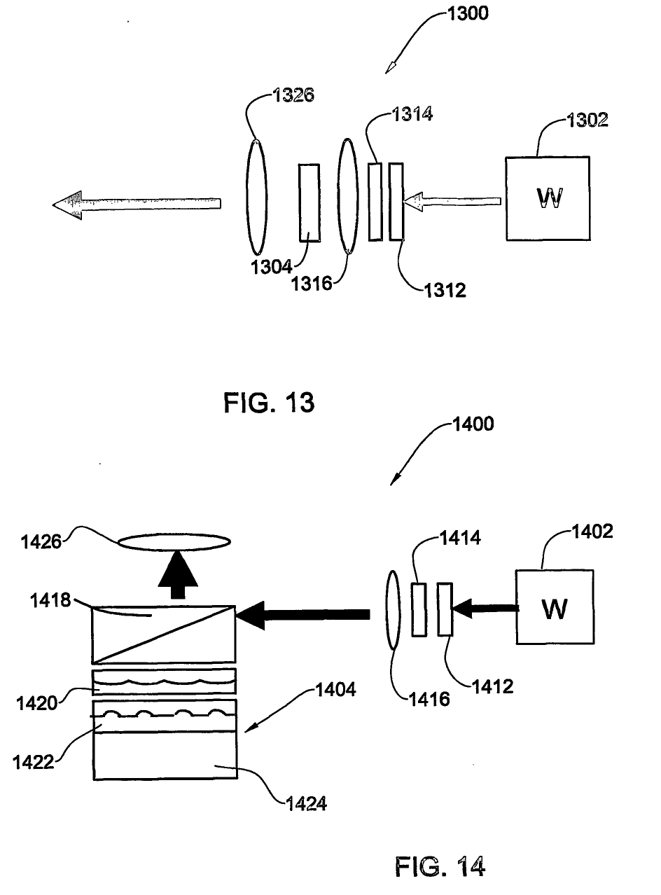

FIG. 13 shows a projection system 1300 using one transmissive-type SLM unit 1304 and a single white polarized light source (polarized LED) 1302. Light generated by the LED is directed towards a focusing lens 1316 (preferably via a polarizing modification element 1312 and a diffractive element 1314) to be focused onto the SLM 1304 over the clear aperture of the SLM. In the SLM unit, light can be either filtered by CF (color filter) to form the R, G, B combination needed for a colorful image, or can be refracted by lenslet arrays to form all the required colors in order to create a color image. Modulated light is then magnified and projected forward by an imaging lens 1326.

FIG. 14 illustrates a projection system 1400 using a single reflective SLM 1404 and a single white polarized light source (polarized LED) 1402. Light from the light source is directed via a polarizing modification element 1412, a diffractive element 1414 and a focusing lens 1416. The latter focuses light in a desired size towards a polarization beam splitter 1418 in a manner to cover the entire entrance area of the beam splitter. A particular polarization component of this light is directed by the beam splitter 1418 towards the SLM unit 1404 (i.e., towards its LC pixel assembly 1424 via first and second lens array 1420 and 1422). Within its entrance to the SLM, the light can be either filtered by CF (color filter) to form the R, G, B combination needed for a colorful image, or can be refracted by the lenslet arrays to form all the required colors in order to create a color image. The light beam thus passes through every active pixel relatively, and then, being modulated and reflected back from a back mirror coating (not shown) and returns back to the beam splitter 1418. As the returned light is polarized opposite to the input light, this returned light passes through the polarizing surface of the beam splitter, to be then magnified and projected forward by an imaging lens 1426.

The present invention also provides for making a projection system very small (e.g., less than 2 cm³ in size), which allows integrating the system within different mobile devices, giving them the capability of delivering large projected video images without enlarging the devices' physical size. In order to utilize a projection system in a reduced physical size, all the optical elements must be miniaturized. Light sources used in the projection module are laser light sources, such as Vertical Cavity Surface Emitting Laser Sources (VCSEL, which is a semiconductor laser including an active region sandwiched between mirror stacks that can be semiconductor distributed Bragg reflectors), laser dies, etc.

A projection module basically consists of miniature two dimensional VCSEL array sources used as pumping sources to pump a lasing crystal (such as Nd:YVO4) and non linear crystals (such as KTP/BBO) in order to obtain a visible light channel. Two such channels are formed for two different colors—Green and Blue. As for the Red channel, it is formed by a two dimensional array of Red laser dies. It should be noted that using other laser light sources is also possible, for example Red VCSEL array. (either directly or after frequency doubling). By the usage of a special planar waveguide as an optical path, the projection module is kept miniaturized together with the possibility of adding special optical processing elements to allow colorful images to be formed. By recording a grating on top of a glass wafer, light is input into a planar wafer\waveguide at different position (larger than 45 degrees).

Light generated by a light source passes a tophat/tophatlet element. For Green- and Blue-color sources, where the output is only one light beam, a tophat element is used, whereas for Red light source, which is an array of laser die sources, the tophatlet element is used. The use of a tophat is aimed at converting a Gaussian beam shape into a rectangular unified beam. A tophatlet provides for combining multiple light sources within a light source array (each having Gaussian beam shape) into a one rectangular unified beam. The tophat\tophatlet element may actually be composed of two sub-elements located apart from each other.

Light emerging from the tophat\tophatlet element passes through a special optical element that is used as a wavelength diffraction mask, which influences differently on different wavelengths. This wavelength combining element acts as wavelength sensitive periscope and is aimed at combining light beams that are coming from three optical paths (Red, Green and Blue), each in a different wavelength, and at a different angle into a single light path towards an SLM unit. An output lens arrangement and grating are used to project images correctly outwards, according to the application (in some cases some optical corrections might be needed, as will be described below).

The invention provides for adjusting a projected picture according to the eye deformation of a specific viewer, thus allowing the viewer not to use eyeglasses. This may be achieved in any of the following ways: For simple eye deformations, an output imaging lens can be shifted (electronically or mechanically) relative to the SLM, thus adding a spherical phase profile to the projected image. For more complex eye deformations (for example: cylinder), an electronically adjustable/configurable phase mask element (e.g. phase SLM) can be inserted into the projection system between the SLM and the imaging lens, allowing higher flexibility in correcting deformations. The image can be also deformed in the SLM itself (if supporting also phase deformation), in an inverse manner to the eye's deformation.

The present invention provides for combining a novel light source technology with special beam shaping, and using this combination as a key to the utilization of ultra small projection systems, enabling variety of applications for such technology.

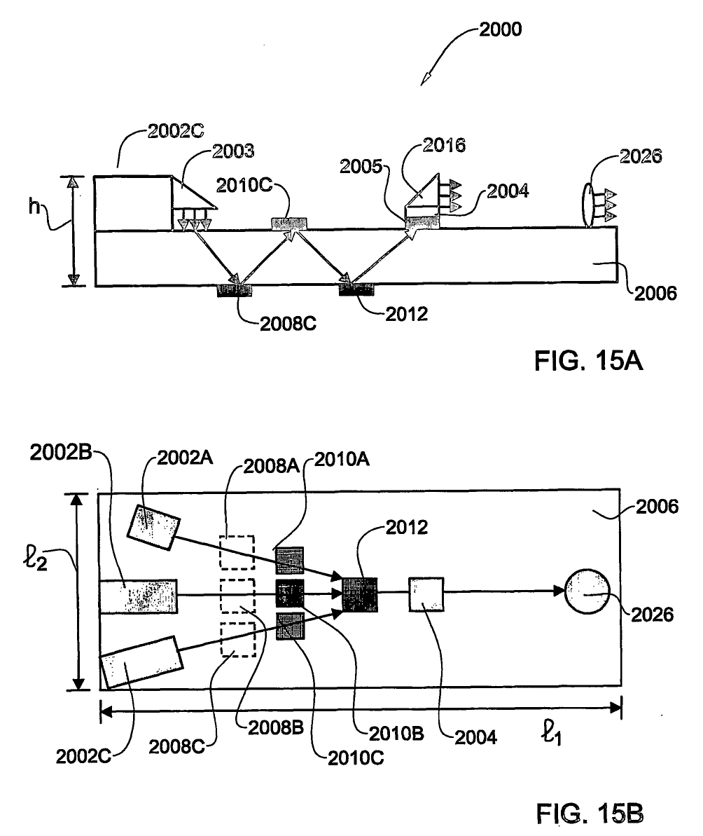

Reference is made to FIGS. 15A and 15B showing side and top views, respectively, of a projection system (module) 2000 of the present invention. The module design is based on planar optical configuration, while combination and redirection of Red-, Green- and Blue-color beams are implemented by using the same optical element. Light sources 2002A (Red), 2002B (Green) and 2002C (Blue) produce light beams to be projected towards prisms 2003 (not shown in FIG. 15B). This prism 2003 diverts the respective light beam down towards a planar optical element 2006 (glass wafer). A grating is recorded on top of the glass wafer 2006, thus causing light to enter the planar wafer at a defined angle (larger than 45 degrees). The planar wafer element 2006 functions as a beam shaping and wavelength combining arrangement in the form of a waveguide, and as long as the light beam's angle is large enough to maintain total internal reflection, all of the light energy will be maintained within the waveguide.

The light beams bounce and then pass through tophat\tophatlet elements, each including a sub-element 2008A configured for phase modulation and preferably also a sub-element 2010A configured for phase correction (for red-color channel), 2008B and 2010B (for green-color channel), and 2008C and 2010C (for blue-color channel). Elements 2008A-2008C thus present a phase modulation arrangement, and elements 2010A-2010C present a phase correction arrangement (the provision of which is optional). The tophat\tophatlet elements operate to convert the brightness distribution in the respective light beam into unified distribution. All these elements (2008A-2008C and 2010A-2010C) are designed such that the total internal reflection condition is maintained, therefore light does not escape from the waveguide. Element 2008A (and 2008B, 2008C) is designed so as to affect the phase of the respective light beam such that the beam profile will change from Gaussian profile to tophat (rectangular) profile after a pre-determined propagation distance. The element 2010A (and 2010B and 2010C) acts on the advanced waves in the respective beam to correct the phase distribution (e.g., smoothing rapid spatial phase changes).

The three R-, G-, B-channels propagate towards a common spectral phase adjusting element 2012. The element 2012 acts as a wavelength sensitive periscope for correcting the phases of three light beams, and thus combining the beams coming from all three paths, each in a different wavelength, into a single output path and directs the combined beam towards an SLM unit 2004. Light, propagating to the SLM unit, passes through an additional diffractive element 2005 that allows light to exit the waveguide by breaking the total internal reflection relation. In the case of a transmissive-type SLM, light emerging from the SLM unit 2004, is directed by a prism 2016 towards an output imaging lens 2026, and projected outwards. In the case of a reflective-type SLM unit, light would be reflected by the SLM unit 2004 back into the waveguide and continue to propagate through the waveguide until it hits a similar grating thus escaping the waveguide to a prism similar to prism 2016.

The height/thickness h of the entire module 2000 can be of about 6 mm and smaller. The overall physical size (l₁ and l₂) of the module can be smaller than 22 mm and 12 mm, respectively.

It should be noted that, although in the present example the light sources are oriented so as to direct light towards planar waveguide 2006 by prism 2004, the light sources could be designed to output light downwards, i.e., into the waveguide 2006, thus eliminating the need for prism 2004. It should also be noted that tophat\tophatlet element may be a single-part element, rather than being composed of two sub-elements. Laser light sources can be of any type (VCSELs, laser dies, etc), operating in any desired wavelength range, used alone or together with any type of crystal material (for example: Nd:YVO4, KTP, BBO, etc.) and possibly together with standard beam shaping optical elements.

It should be also noted that the spectral phase adjusting element 2012 can operate in free space as well as in the planar waveguide and can replace any wavelength combining periscope configuration. Such a combining element has an increased depth pattern. The generation of the wavelength combining element responsible for the multi-wavelength processing may be realized by a recording method in which a mask is positioned a given distance from the recording surface in such a way that given the special transformation relating the plane of the mask and the recording plane generate the desired profile on the recording surface using photolithographic techniques.

Turning for example to FIG. 2B or FIG. 3, it should be understood that the system 2000 can form a projection channel of the system of FIG. 2B or 3.

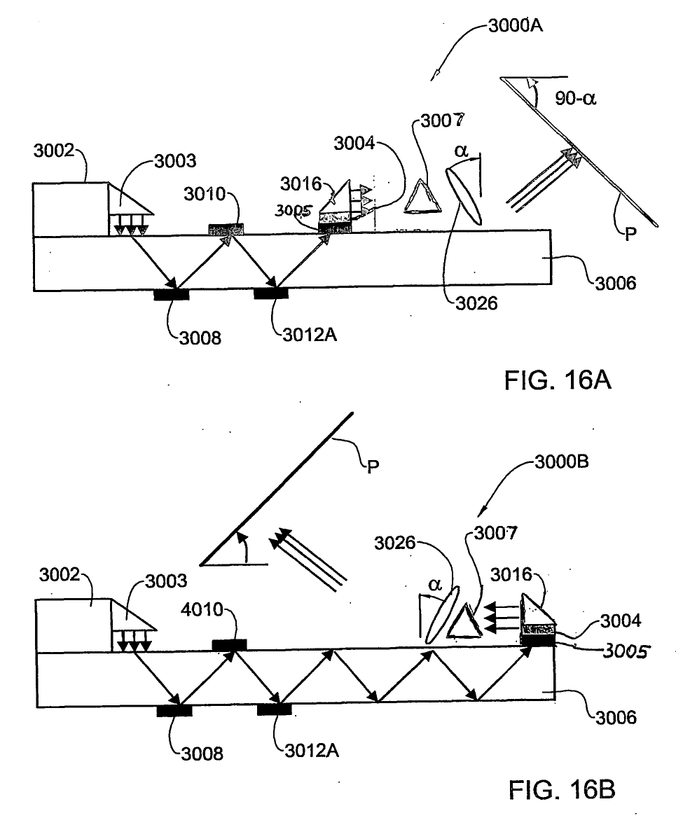

FIGS. 16A and 16B exemplify ultra small projection systems 3000A and 3000B, respectively, configured to be embedded in a mobile device, for example, cellular flip top phone device. Both systems 3000A and 3000B are exemplified as operating in a rear projection mode (e.g., embedded in a cellular phone).

The system 3000A is generally similar to that of FIGS. 15A-15B, and distinguishes therefrom in that an output imaging lens 3026 is preceded with a prism 3007 that diverts the light toward the screen (projection surface P), and by having the lens slanted in an angle α corresponding to an angle of the flip displaying surface P. Varying the angle of the prism 3007 and the lens 3026 allows for correcting of aberrations caused by that the displaying surface (the flip) is slanted relative to the projected image which is coming out of prism 3016.

System 3000B distinguishes from system 3000A in that the prism 3016 and SLM 3004 are located close to the edge of the planar waveguide 3006. Prism 3016, which is here horizontally 180-degrees rotated as compared to that of system 3000A, outputs the projected image towards the correction prism 3007 and imaging lens 3026, which is slanted in order to correct the aberrations caused due to the fact that the displaying surface P (the flip) is not perpendicular relative to the projected image which is coming out of prism 3016.

It should be noted that, although in the present example, rear projection mode is demonstrated, the principles of the present invention can be used with other modes of projection (for example, front projection), in which case some variations in the system architecture are needed (for example, the projection surface and imaging lens would be located elsewhere). In a similar manner, the architecture could be used to operate alternatively/simultaneously between two projection cannels, as described above.

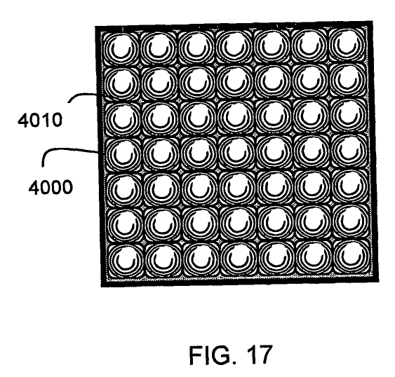

FIG. 17 illustrates a tophatlet element 4000 which could be used in the projection systems of the above-described examples. The tophatlet element 4000 is made of an array of micro tophat elements 4010, each with the properties of a regular tophat element. Each sub-element 4010 in the array of tophats 4000 corresponds individually to a specific beamlet within a 2D light source array (for example, a laser die array, as in FIGS. 15A-15B). Each sub-element 4010 in the tophatlet element operates to unify the light brightness distribution of the specific beamlet corresponding thereto.

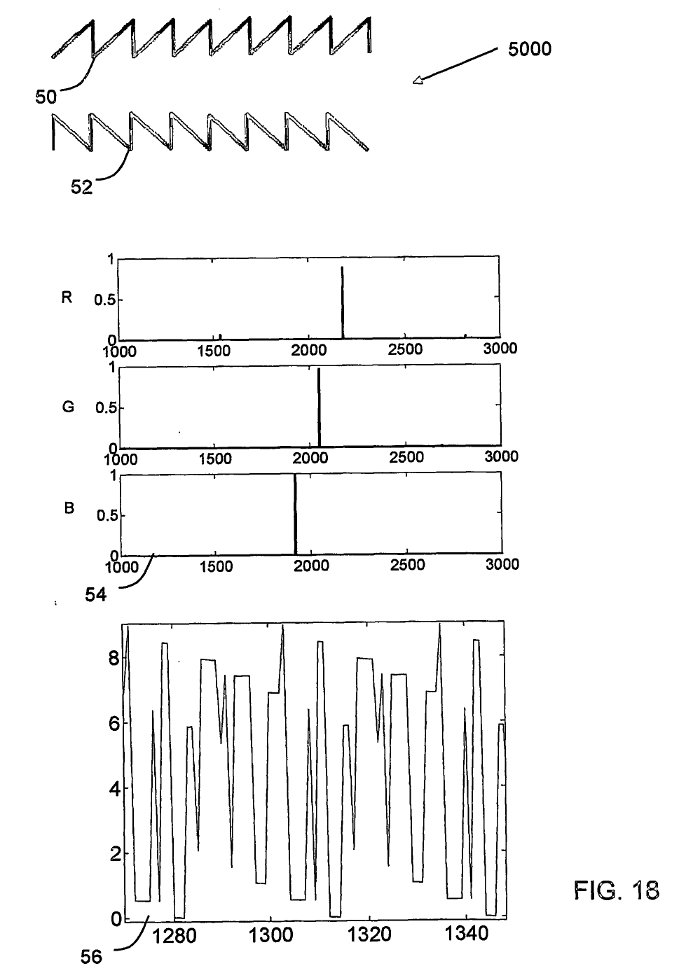

FIG. 18 more specifically illustrates the operational principles of a wavelength combining element (e.g., 2012 in FIGS. 15A-15B). As indicated above, the wavelength combining element acts as wavelength sensitive periscope and its purpose is to combine the beams that are coming from three paths (Red, Green and Blue channels), each in a different wavelength, into a single light path towards an SLM unit. The wavelength-combining element is designed such that each one of the three wavelengths experiences a different spatial structure. Since each wavelength is indifferent to phase accumulation of whole number of (2π) but each wavelength will accumulate the 2π phase going through a different height, the result is that each wavelength responds differently to the same physical height. Mathematically, that relation may be expressed as:
h=h_{R}(modλ_{R})=h_{G}(modλ_{G})=h_{B}(modλ_{B}) (1)
where h is the physical height at any given point, h_{R}, h_{G}, and h_{B} are the heights “sensed” by the R, G and B wavelengths, respectively, and λ_{R}, λ_{G} and λ_{B} are the respective wavelengths of R, G and B.

The height of the element was increased up to approximately 20 wavelengths, and the optimal function allowing realizing different filter per each wavelength was found.

The following equation depicts the width of the element:

$$d ( x ) = \frac{{λ}_{k} {ϕ}_{k} ( x )}{2 π} + {λ}_{k} {m}_{k} ( x ) ∀ k = 1 , 2 , 3 \qquad ( 2 )$$

where λₖ is the three wavelengths and mₖ is an integer that could be a different one per each wavelength. φₖ is the required phase function per each wavelength (R, G and B).

Turning to FIG. 18, the model is aimed at realizing a design at which the red (R) wavelength will experience phase function 50, the green (G) will experience a constant phase, and the blue (B) will experience the phase function 52. That way the red beam will be diverted to the left, the green will continue straight ahead and the blue will be diverted to the right.

The design is optimized by adjusting the relative transversal shift between the phases of the R and the B and the constant level of the phase for the G. A recursive algorithm was constructed and demonstrated for an example of three wavelengths: 457 nm, 532 nm and 650 nm. To demonstrate the above mentioned design, the width d(x) was allowed to vary up to 20 wavelengths (approximately 10 microns), and the spatial period of the structure of FIGS. 16A and 16B was also 20 wavelengths, in order to realize a prism that deflects the light at 45 degrees.

It should be noted that the relation described in Eq. 2 can also be formulated as:

$${m}_{j} ( x ) = \frac{{λ}_{i} {ϕ}_{i}}{2 {πλ}_{j}} + \frac{{λ}_{i}}{{λ}_{j}} {m}_{i} ( x ) - \frac{{ϕ}_{j} ( x )}{2 π} \qquad ( 3 )$$

where φᵢ could, for example, be the phase of the G optical path which is aimed to be constant for all x (x is the transversal axis). In this case, i is the index corresponding to G, and j would ‘scan’ the indexes of the R and B.

One possible numerical algorithm that extracts the optimal mⱼ values includes the following routine:
Choose various set of values for m1 and obtain values for m2 and m3 from Eq. 3. The obtained values are not integer. Thus, round them and compute the error obtained due to the rounding.
Per each set of values of mⱼ, find the maximal error and choose the minimal error out of all the obtained sets. The set that provides this error is the chosen one (local optimum).
The same procedure is repeated when values of m2 are fixed and m1 and m3 are computed out of Eq. 3 and when the value of m3 is fixed and m1 and m2 are extracted out of Eq. 3.

The output of the algorithm produces three suggestions for mⱼ per each spatial location x. Out of the three proposals, that one was chosen that gives the smallest error.

Diagram 54 (FIG. 18) presents the Fourier transforms of the elements obtained for the R, G and the B respectively in the example above. As shown, for R-color, indeed most of the energy is deflected to the (−1) diffraction order, for G-color it goes to the zero order, and for B-color it is in the first order. The obtained energetic efficiency of the element is 87%, 95% and 98.3% for the R, G and the B respectively.

It should be noted that the relations described in Eq. 2 could be solved using the suggested recursive algorithm for more than three discrete wavelengths. Optimization of the suggested algorithm could be performed when M quantization levels are constrained on the possible phase values. In that case, a set of M discrete equations are derived out of Eq. 3.

Diagram 56 in FIG. 18 represents a possible actual depth pattern that achieves the above multi-wavelength combining.

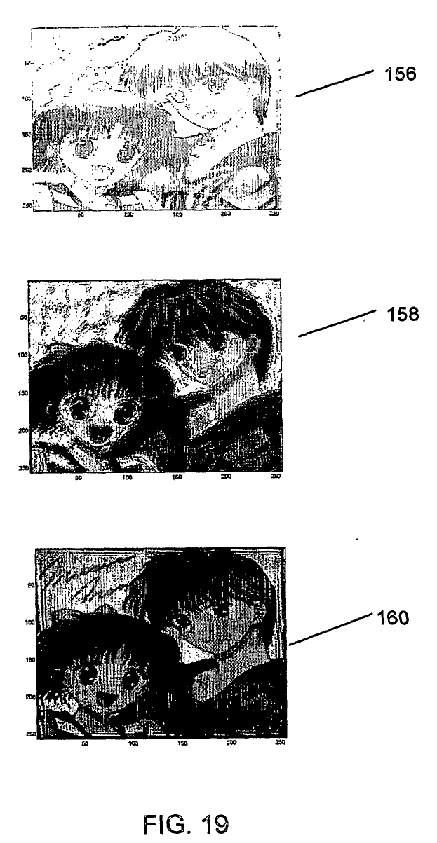

FIG. 19 exemplifies the eye deformations of a viewer requiring eye glasses, and how they are corrected. A method, dealing with the ability to adjust the projected picture according to the eye deformation of a specific viewer (allowing the viewer to not require the usage of eyeglasses), is based on the design in FIGS. 1-8 and 15A-15B and 16A-16B.

The eyeglasses provide a chirp like distortion to the image that may be mathematically expressed as a convolution between the distorting chirp function and the observed image. The distortion existing in the lens of the viewer's eyes, prevent the eyes from focusing on the required image plane. By creating a virtual screen, the observer can view the corrected images without the need to wear eyeglasses. Since the distortion is a convolution between the observed image and a chirp phase function, regular screens cannot provide this correction, since the distortion is a phase function and it is a convolution rather than a multiplication operation. Using a projection system, the screen is not located at the same plane as the image generator (SLM), thus a convolution with a phase chirp function can be created. The fact that laser light sources are used is also important since they may generate a phase distribution that cannot be obtained with regular incoherent light.

For simple eye deformations, the output imaging lens (2026 in FIG. 16A-16B) can be shifted relative to the SLM (2004) adding a spherical phase profile to the projected image. For more complex eye deformations (for example: cylinder), an electronically adjustable/configurable phase mask element (e.g. phase SLM) can be inserted between the SLM and the imaging lens, allowing higher flexibility in correcting deformations. The image can be also deformed in the SLM itself (if supporting also phase deformation), in an inverse manner to the eye's deformation.

FIG. 19 demonstrates the above assuming a viewer with Diopter of three. An original image 156 is observed by the viewer correctly as long as the eyeglasses are used. As the eyeglasses are removed, a distorted image 158 (doesn't appear right within drawing) is created in the eyes of the observer. By using a laser projection system with the required phase correction, the corrected image 160 (doesn't appear right within drawing) is clearer and viewable by the observer, without the use of eyeglasses. As could be seen, the distortions are corrected and the distorted spatial frequencies are restored. Although the distortions were eliminated, a phase distortion is created due to the fact that the screen on which the image is projected on is not completely plain. This distortion doesn't necessarily interfere in viewing the projected images.

Those skilled in the art will readily appreciate that various modifications and changes can be applied to the embodiments of the invention as hereinbefore described without departing from its scope defined in and by the appended claims.

1. A projection system configured to operate with at least one of first and second projection modes, the system comprising:
(i) a light source system including one or more light source assemblies, the light source assembly being operable to generate light of one or more predetermined wavelength range;
(ii) a spatial light modulator (SLM) system including one or more SLM units operable to spatially modulate input light in accordance with an image to be directly projected or viewed;
(iii) two optical assemblies associated with two spatially separated light propagation channels, respectively, to direct light to, respectively, the first and second projection planes with desired image magnification;
the system being configured to selectively direct the input light propagating towards the SLM system or light modulated by the SLM system to propagate along at least one of the two channels associated with the first and second projection planes, respectively.

2. The system of claim 1, wherein the SLM unit is configured to operate in a light reflection mode or light transmitting mode.

3. (canceled)

4. The system of claim 1, wherein the SLM system comprises the single SLM unit associated with said first and second projection planes; or comprises two SLM units accommodated in said two channels, respectively.

5. The system of claim 41, wherein the SLM system comprises two SLM units accommodated in said two channels, respectively, and associated with the single light source assembly.

6. (canceled)

7. The system of claim 1, comprising a polarization separating element defining said two channels of light propagation.

8. The system of claim 7, wherein said polarization separating element has one of the following configurations: is configured as a linearly polarized beam splitter; and is configured as a magneto-optical circularly polarized beam splitter.

9. (canceled)

10. The system of claim 7, comprising a controllable polarization rotator, an operational position of the polarization rotator determining the selective light propagation along one of the two channels or along both of them.

11. The system of claim 10, having one of the following configurations:
the polarization rotator is accommodated upstream of the polarization separating element with respect to a direction of light propagation from the light source assembly towards the projection planes;
said polarization separating element and the polarization rotator are accommodated downstream of the reflective-type SLM unit;
said polarization separating element and the polarization rotator are accommodated downstream of the transmissive-type SLM unit;
said polarization separating element and the polarization rotator are accommodated upstream of the transmissive-type SLM system; and
comprises a second polarization rotator accommodated at one of two outputs of the polarization separating element, and a mirror accommodated downstream of the second polarization rotator, said mirror reflecting the light component coming from said output of the polarization separating element back to said polarization separating element through said second polarization rotator.

12. The system of claim 10, wherein the polarization rotator is accommodated upstream of the polarization separating element with respect to a direction of light propagation from the light source assembly towards the projection planes, the polarization separating element and the polarization rotator being accommodated upstream of the reflective-type SLM unit.

13. The system of claim 12, comprising first and second mirror assemblies accommodated in the two channels, respectively, each of the mirror assemblies being configured to direct a respective polarization light component output from the polarization separating element onto the SLM unit with an angle of incidence different from that of the other polarization light component output from the polarization separating element.

14. (canceled)

15. The system of claim 10, wherein said polarization separating element and the polarization rotator are accommodated downstream of the reflective-type SLM unit, the system comprising a second polarization separating element accommodated so as to be in an optical path of the input light propagating towards the SLM unit to reflect the input light to the SLM unit and in an optical path of the modulated light emerging from the SLM unit to transmit the modulated light towards the polarization rotator.

16. (canceled)

17. (canceled)

18. The system of claim 10, wherein said polarization separating element and the polarization rotator are accommodated upstream of the transmissive-type SLM system, the SLM system comprising two SLM units accommodated at two outputs, respectively, of the polarization separating element.

19. (canceled)

20. The system of claim 10, comprising a second polarization rotator accommodated at one of two outputs of the polarization separating element, and a mirror accommodated downstream of the second polarization rotator, said mirror reflecting the light component coming from said output of the polarization separating element back to said polarization separating element through said second polarization rotator, the transmissive-type SLM unit being accommodated upstream of the first polarization rotator.

21. The system of claim 7, comprising a partially transparent mirror at one of two outputs of the said polarization separating element, said polarization separating element being accommodated so as to be in an optical path of the input light propagating towards the reflective-type SLM to reflect the input light to the SLM unit, unit and in an optical path of the modulated light output from the SLM unit to transmit the modulated light to said partially transparent mirror.

22. The system of claim 7, comprising a mirror shiftable between its operative position being located at one of two outputs of the said polarization separating element and inoperative position being outside outputs of said polarization separating element, said polarization separating element being accommodated so as to be in an optical path of the input light propagating towards the reflective-type SLM to reflect the input light to the SLM unit, unit and in an optical path of the modulated light output from the SLM unit to transmit the modulated light to said one of the two outputs.

23. The system of claim 1, wherein the SLM system comprises the single SLM unit, the system comprising a mirror shiftable between its operative position when its reflective surface is oriented towards an output of the SLM unit so as to reflect the modulated light towards the respective one of the first and second projection planes, and its inoperative position being located outside an optical path of the modulated light thus allowing said modulated light to propagate towards the other projection plane, the system thereby selectively operating with one of the first and second projection modes.

24. The system of claim 1, wherein the SLM system comprises the single SLM unit displaceable between its first and second operative positions in which it receives the input light coming from first and second propagation directions, respectively, and outputs the modulated light towards, respectively, the first and second projection planes.

25. The system of claim 24, wherein the light source system has one of the following configurations: comprises first and second light source assemblies accommodated so as to direct the first and second generated light in said first and second propagation directions, respectively; and comprises the single light source assembly mounted for movement between its first and second operative positions in which it directs the generated light in said first and second propagation directions, respectively.

26. (canceled)

27. The system of claim 1, wherein the SLM system comprises the single SLM unit, the system comprising a first array of optical elements located at the output of the SLM unit, said first array being formed by alternating lenses and prisms, the lenses substantially not affecting a direction of light components impinging thereon and thus allowing propagation of said light components towards the respective one of the first and second projection planes, and the prisms of said first array deflecting light components impinging thereon towards the other projection plane.

28. The system of claim 27, comprising a second array of prisms accommodated in an optical path of the light components deflected by the prisms of the first array to correct for dispersion effects of the first prisms.

29. The system of claim 27, wherein each of said first and second light components emerging from the first array is indicative of a half of pixel arrangement of the SLM unit set for one of the two projection channels.

30. The system of claim 7, comprising a mirror accommodated at one of two outputs of the said polarization separating element and oriented at a certain angle to an axis of propagation of light coming from said output of the said polarization separating element, said polarization separating element being accommodated so as to be in an optical path of the input light propagating towards the reflective-type SLM unit to reflect the input light to the SLM unit, and in an optical path of the modulated light output from the SLM unit to transmit the modulated light, an assembly formed by said polarization separating element and the mirror being rotatable about said axis between two operative positions of said assembly with respect to the SLM unit, such that in one of these operative positions the light output from the said polarization separating element is reflected by said mirror towards one of the first and second projection planes and in the other operative position the output light is reflected by said mirror towards the other projection plane.

31. The system of claim 1, wherein the light source assembly is configured to generate at least two light beams of different wavelength ranges.

32. The system of claim 31, wherein the light source assembly is configured to generate light of Red, Green and Blue wavelength ranges.

33. The system of claim 31, wherein the generated light beams have particular polarization.

34. The system of claim 1, wherein the light source assembly is configured to provide substantially uniform intensity distribution within a cross-section of the generated light.

35. The system of claim 34, wherein the assembly comprises a diffractive element.

36. The system of claim 31, having at least one of the following configurations: comprising a light combining arrangement accommodated either in optical paths of at least two input light beams propagating towards the single SLM unit, or in optical paths of at least two modulated light beams coming from the at least two SLM units, respectively, the light combining arrangement thereby producing a combined multi-wavelength output light beam.

37. The system of claim 36, comprising at least two polarizing modification elements in optical paths of said at least two generated light beams, respectively, propagating towards the light combining arrangement, the polarizing modification element being configured for modifying polarization qualities of the respective beam.

38. The system of claim 37, wherein the polarizing modification element is a quarter wave plate.

39. The system of claim 37, wherein the polarizing modification element is configured for converting circular polarization of the beam to linear polarization.

40. The system of claim 31, comprising a wavelength combining arrangement accommodated in an optical path of said at least two light beams of different wavelengths and operating to combine said at least two light beams into a combined light beam and direct the combined light beam towards the SLM unit.

41. The system of claim 40, wherein the wavelength combining arrangement comprises a spectral phase adjusting element.

42. The system of claim 41, wherein said wavelength combining arrangement comprises a planar optical element operable as a light-guide for light incident thereon with an angle corresponding to a total internal reflection condition to thereby maintain substantially all the energy of the incident light within the light-guide; and a first light director assembly accommodated in optical paths of the at least two input light beams to direct them onto said planar optical element with said predetermined angle of incidence, said spectral phase adjusting element being accommodated in the optical path of light propagating in the planar optical element.

43. The system of claim 41, wherein the wavelength combining arrangement comprises a phase modulation arrangement including at least two phase modulation elements in the optical paths of said at least two light beams, respectively.

44. The system of claim 43, wherein the wavelength combining arrangement comprises a phase correction arrangement including at least two phase correcting element accommodated in optical paths of the at least two light beams, respectively, with the modulated phase.

45. The system of claim 42, wherein the wavelength combining arrangement comprises a phase modulation arrangement including at least two phase modulation elements in the optical paths of said at least light beams, respectively, propagating towards the spectral phase adjusting element; a phase correction arrangement including at least two phase correcting elements accommodated in optical paths of the at least two light beams, respectively, with the modulated phase propagating towards the spectral phase adjusting element; said phase modulation arrangement, said phase correction arrangement and said spectral phase adjusting element being located on surfaces of the planar optical element.

46. An image projecting method, the comprising:
operating a spatial light modulating (SLM) system, including one or more SLM units located in the propagation of input light coming from one or two light source assemblies to modulate the light in accordance with the image to be projected, the light source assembly being configured to generate light of one or more predetermined wavelength range; and operating said one or more SLM unit to modulate input light in accordance with the image to be projected; and
selectively directing the input light propagating towards the SLM system or light modulated by the SLM system to propagate along at least one of first and second light propagation channels associated with first and second projection planes, respectively to thereby project the image onto at least one of the first and second planes.

47. The method of claim 46, wherein the selective direction of the input light comprises passing the input light through a controllable polarization rotator and through a polarization separating element, an operational position of the polarization rotator determining the selective light propagation along one of the first and second channels or along both of them.

48. The method of claim 47, comprising providing first and second mirror assemblies in first and second outputs of the polarization separating element, respectively, the first and second mirror assemblies being configured so as to direct first and second output light components of the polarization separating element towards the reflective-type SLM unit with different angles of light incidence onto the SLM unit, thereby providing first and second output light components of the SLM unit propagating towards the first and second projection planes, respectively.

49. The method of claim 47, comprising: directing the input light onto the first polarization separating element oriented so as to reflect the input light towards the SLM unit and transmit the modulated light output from the SLM unit to the polarization rotator; directing the modulated light emerging from the polarization rotator to a second polarization separating element oriented so that its two output facets are associated with the first and second projection planes.

50. The method of claim 46, wherein the selective direction of the input light comprises carrying out one of the following:
passing the input light, propagating towards the reflective-type SLM unit, through a polarization separating element oriented so as to reflect the input light towards the SLM unit and transmit the modulated light output from the SLM unit; and selectively carrying out one of the following: allowing passage of the transmitted modulated light directly towards one of the first and second projection planes, and directing the modulated transmitted light onto a mirror configured to at least partially reflect the light back into the polarization separating element to be reflected thereby towards the other projection plane;
passing the input light, propagating towards the reflective-type SLM unit, through a polarization separating element oriented so as to reflect the input light towards the SLM unit and transmit the modulated light output from the SLM unit; and directing the modulated transmitted light onto a mirror selectively oriented to reflect said light to either one of the first and second projection planes;
passing the modulated light, output from the SLM unit, through a controllable polarization rotator and sequentially directing the light emerging from the polarization rotator onto a polarization separating element, an operational position of the polarization rotator determining the selective light propagation along one of the first and second channels or along both of them;
selectively reflecting the modulated light, output from the SLM unit, to one of the first and second projection planes or allowing the modulated light propagation directly towards the other projection plane;
passing the modulated light, output from the SLM unit, through an array formed by alternating lenses and prisms, thereby spatially separating said light into first light components impinging onto the lenses and thus propagating along the first channel towards the first projection plane, and second light components impinging onto the prisms and thus propagating along the second channel towards the second projection plane;
displacing the SLM unit between its first and second operational positions, in its first operational position the SLM unit being oriented such that it receives first light from the first light source assembly and provides first output light propagating towards the first projection plane, and in the second operation position of the SLM unit being oriented so as to receive second light from the second light source assembly and provide second output light propagating towards the second projection plane.

51. (canceled)

52. (canceled)

53. The method of claim 46, wherein the selective direction of the modulated light comprises passing the modulated light, output from the SLM unit, through a controllable polarization rotator and sequentially directing the light emerging from the polarization rotator onto a polarization separating element, an operational position of the polarization rotator determining the selective light propagation along one of the first and second channels or along both of them, the method comprising reflecting a polarized light component transmitted through the polarization separating element back into said polarization separating element to be reflected by said polarization separating element towards a respective one of the first and second projection planes.

54. (canceled)

55. (canceled)

56. The method of claim 55, wherein the selective direction of the modulated light comprises passing the modulated light, output from the SLM unit, through an array formed by alternating lenses and prisms, thereby spatially separating said light into first light components impinging onto the lenses and thus propagating along the first channel towards the first projection plane, and second light components impinging onto the prisms and thus propagating along the second channel towards the second projection plane, the method comprising affecting the light propagation in said first and second channels to correct for missing pixels caused by the separation between the first and second light components.

57. (canceled)

58. The method of claim 46, comprising providing the input light in the form of at least two light beams of different wavelength ranges.

59. The method of claim 58, wherein the light beams include three light beams of respectively, Red, Green and Blue wavelength ranges.

60. The method of claim 58, comprising providing a particular polarization of the light beams.

61. The method of claim 46, comprising affecting the input light to provide substantially uniform intensity distribution within a cross-section of the light beam.

62. The method of claim 58, comprising passing the input light through a wavelength combining arrangement thereby producing the combined multi-wavelength input light beam.

63. The method of claim 62, wherein the wavelength combining arrangement is accommodated in optical paths of either at least two input light beams generated by the at least two light sources respectively and propagating towards the single SLM unit, or at least two modulated light beams coming from the at least two SLM units, respectively.

64. The method of claim 62, wherein the wavelength combining arrangement is accommodated in optical paths of at least two modulated light beams coming from the at least two SLM units, respectively, the method comprising passing each of at least two light beams, generated by the at least two light sources, respectively, and propagating towards the wavelength combining arrangement, via a respective polarizing modification element configured for modifying polarization qualities of the respective beam.

65. The method of claim 64, wherein the polarizing modification element is a quarter wave plate.

66. The method of claim 64, wherein the polarizing modification element is configured for converting circular polarization of the beam to linear polarization.

67. The method of claim 62, wherein said wavelength combining arrangement comprises a spectral phase adjusting element and is accommodated in optical path of the at least two input light beams generated by the at least two light sources, respectively, and propagating towards the single SLM unit.

68. The method of claim 62, wherein said wavelength combining arrangement is accommodated in optical paths of the at least two input light beams generated by the at least two light sources, respectively, and propagating towards the single SLM unit, and comprises a planar optical element operable as a light-guide for light incident thereon with an angle corresponding to a total internal reflection condition to thereby maintain substantially all the energy of the incident light within the light-guide; the method comprising affecting propagation of the input light beams towards the planar optical element to direct the beams onto said planar optical element with said predetermined angle of incidence.

69. The method of claim 62, comprising modulating a phase of each of the light beams.

70. The method of claim 69, comprising correcting phases of the light beams with the modulated phases.

71. (canceled)

72. The system of claim 36, wherein the wavelength combining arrangement has one of the following configurations: comprises a periscope with thin dichroic reflectors accommodated in the optical paths of said at least two generated light beams; comprises a combining cube accommodated in the optical paths of said at least two modulated light beams; and comprises a spectral phase adjusting element to enable combining of said at least two light beams of different wavelengths into a combined light beam.

73. (canceled)

74. (canceled)

75. The system of claim 36, wherein the wavelength combining arrangement comprises a spectral phase adjusting element to enable combining of said at least two light beams of different wavelengths into a combined light beam; and a planar optical element operable as a light-guide for light incident thereon with an angle corresponding to a total internal reflection condition to thereby maintain substantially all the energy of the incident light within the waveguide.

76. The system of claim 75, comprising a first light director assembly accommodated in optical paths of the at least two generated light beams to direct them onto said planar optical element with said predetermined angle of incidence.

77. The system of claim 36, wherein the wavelength combining arrangement comprises a spectral phase adjusting element to enable combining of said at least two light beams of different wavelengths into a combined light beam, the system comprising a phase modulation arrangement including at least two phase modulation elements in optical paths of said at least two light beams.

78. (canceled)

79. The system of claim 76, wherein said first light director assembly is a mirror or prism.

80. The system of claim 77, wherein the phase modulation element is a tophat diffractive optical element, allowing changing of the beam profile from the incident Gaussian profile to rectangular profile after a pre-determined propagation distance.

81. The system of claim 75, wherein the spectral phase element is a diffractive optical element designed by increasing a depth of a pattern such that incident light beams with different wavelengths sense different diffractive elements corresponding to each wavelength, thereby outputting the input light beams of different wavelengths impinging onto the spectral phase element with different angle in the same spatial direction.

82. The system of claim 76, comprising a second light director assembly accommodated in the optical path of modulated light output from the SLM unit to direct the modulated light to a projection surface.

83. The system of claim 82, comprising an imaging lens arrangement accommodated in an optical path of light output from the second light director assembly.

84. The system of claim 83, wherein the imaging lens arrangement is oriented at an angle corresponding to an angle of orientation of a projection surface, adjusting the angle and off-axis position of the imaging lens arrangement allowing for correcting aberrations caused by a tilt of projection surface relative to a projected image formed by the modulated light.

85. The system according to claim 82, wherein orientation of the second light director assembly is adjustable for system operation in at least one two different projection modes.

86. A method for use in combining at least two light beams of different wavelengths into a combined light beam, the method comprising passing said at least two light beams via a wavelength combining element in the form of a diffractive grating with an increased depth pattern.

87. The method of claim 86, wherein said wavelength combining element is generated by a recording process using a mask positioned at a given distance from a recording surface, such that given a special transformation relating a plane of the mask and the recording surface generate a desired profile on the recording surface.

88. A miniature projection system comprising: a light source system including at least two light source assemblies generating at least two light beams, respectively, of different wavelength ranges; a planar optical element operable as a light guide for light incident thereon with an angle corresponding to a total internal reflection condition to thereby maintain substantially all the energy of the incident light within the waveguide; a first light director assembly accommodated in optical paths of the at least two generated light beams to direct them onto said planar optical element with said predetermined angle of incidence; the planar optical element carrying on its surfaces a phase modulation arrangement including at least two phase modulation elements in optical paths of said at least two light beams, respectively, propagating along the waveguide, and a spectral phase adjusting element accommodated in an optical path of the phase modulated light propagating along the light guide, the phase modulation arrangement and the spectral phase adjusting element acting together to provide beam shaping and wavelength combining to enable combining of said at least two light beams of different wavelengths into a combined light beam and direct the combined light beam towards a spatial light modulator (SLM) unit.
